(19) United States
(12) Patent Application Publication
(10) Pub. No.: US 2011/0025905 A1
(43) Pub. Date: Feb. 3, 2011

(54) IMAGING DEVICE AND OPTICAL AXIS CONTROL METHOD

(76) Inventor: Seiichi Tanaka, Osaka (JP)

Correspondence Address: BIRCH STEWART KOLASCH & BIRCH, PO BOX 747, FALLS CHURCH, VA, 22040-0747, US

(21) Appl. No.: 12/935,489

(22) PCT Filed: Apr. 2, 2009
(86) PCT No.: PCT/JP2009/056875

§ 371 Date: Sep. 29, 2010

(30) Foreign Application Priority Data
Apr. 2, 2008 (JP) 2008-095851

(51) Int. Cl. H04N 5/238

(52) U.S. Cl. 348/362; 348/E05.04

(57) ABSTRACT

To create a high-resolution color image, an imaging device includes: a plurality of green image pickup units picking up images of green components; a red image pickup unit picking up an image of a red component; a blue image pickup unit picking up an image of a blue component; a high-definition synthesis processor adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and a color synthesis processor adjusting an optical axis of light incident to each of the red image pickup unit and the blue image pickup unit, and synthesizing the green image, the red image and the blue image to obtain a color image.

### TECHNICAL FIELD

The present invention relates to an imaging device and an optical axis control method.

This application claims priority to and the benefits of Japanese Patent Application No. 2008-95851 filed on Apr. 2, 2008, the disclosure of which is incorporated herein by reference.

### BACKGROUND ART

In recent years, high-definition digital still cameras or digital video cameras (hereinafter, referred to as digital cameras) have been propagating quickly. In addition, small, thin digital cameras have been developed and small high-definition digital cameras have been mounted to portable telephones.

An imaging device such as a digital camera basically includes an image pickup element and a lens optical system. As the image pickup element, an electronic device such as a complementary metal oxide semiconductor (CMOS) sensor or a charge coupled device (CCD) sensor is used. The image pickup element performs photoelectric conversion on a light amount distribution formed on an image pickup surface and records it as a photographed image. In general, the lens optical system includes several aspherical lenses to eliminate aberrations. For a zoom function, a drive mechanism (actuator) which changes a spacing between a plurality of lenses and the image pickup element is required.

Meanwhile, as higher-definition and more multifunctional imaging devices are demanded, high-definition image pickup elements with multiple pixels, and low-aberration, high-precision imaging optical systems have been developed. Accordingly, the imaging devices have become large and it is difficult to obtain a small, thin imaging device. To resolve such problems, a scheme of using a multi-view structure for a lens optical system, or an imaging device including a plurality of image pickup elements and a lens optical system has been proposed.

For example, an imaging lens device including a solid lens array, a liquid-crystal lens array, and an imaging device having a planar layout has been proposed (e.g., Patent Document 1). The imaging lens device includes a lens system having a lens array 2001 and a varifocal liquid-crystal lens array 2002, which are the same in number, an image pickup element 2003 which picks up an optical image formed through the lens system, an operational device 2004 which performs image processing on a plurality of images obtained by the image pickup element 2003 to reconstruct an entire image, and a liquid crystal driving device 2005 which detects focus information from the operational device 2004 to drive the liquid-crystal lens array 2002, as shown in FIG. 24. According to this configuration, it is possible to realize a small, thin imaging lens device with a small focal length.

Further, a thin color camera having a sub-pixel resolution combining four sub-cameras each consisting of imaging lenses, a color filter, and a detector array has been also proposed (e.g., see Patent Document 2). The thin color camera includes four lenses 22a to 22d, a color filter 25, and a detector array 24, as shown in FIG. 25. The color filter 25 consists of a filter 25a which transmits red light (R), filters 25b and 25c which transmit green light (G), and a filter 25d which transmits blue light (B), and the detector array 24 photographs red, green, and blue images. In this configuration, a high-resolution synthesis image is formed from two green images, to which a human visual system has high sensitivity, and combined with red and blue images to obtain a full color image.

Patent Document 1: Japanese Unexamined Patent Publication, First Publication No. 2006-251613

Patent Document 2: Japanese Patent Application Publication No. 2007-520166

### DISCLOSURE OF INVENTION

### Problem to be Solved by the Invention

However, when a full color image is created using a multi-view imaging device, it is necessary to resolve a color shift problem. As disclosed in Patent Document 2 (FIG. 25), since the thin color camera includes four sub-cameras and the color filter 25 has a Bayer layout, the color shift problem is not severe, but when multiple sub-cameras are included to achieve a high resolution, photographing positions of the respective color sub-cameras are separated from one another, which causes a shift (parallax) between red, green and blue images. Since a relative position between the optical lens system and the image pickup element varies due to, for example, aging even with fine adjustment upon product assembly, the shift is caused. In addition, since a shift amount among red, green and blue images varies with the distance to an object to be photographed (photographing distance), it is hard to cope with the shift through unique adjustment. In a high-resolution, multi-view color imaging device capable of photographing fine patterns, it is highly necessary to resolve a color shift problem upon full color synthesis.

The present invention has been achieved in view of the above circumstances, and it is an object of the present invention to provide an imaging device and an optical axis control method capable of creating a high-resolution full color image without color shift even when a plurality of image pickup elements are equipped in order to increase resolution.

### Means for Solving the Problem

In accordance with an aspect of the present invention, an imaging device including: a plurality of green image pickup units each including a first image pickup element which picks up an image of a green component and a first optical system which forms an image on the first image pickup element; a red image pickup unit including a second image pickup element which picks up an image of a red component and a second optical system which forms an image on the second image pickup element; a blue image pickup unit including a third image pickup element which picks up an image of a blue component and a third optical system which forms an image on the third image pickup element; a high-definition synthesis processor which adjusts an optical axis of light incident to the green image pickup units, so that the resolution of a green image obtained by synthesizing a plurality of images picked up by the plurality of green image pickup units becomes a predetermined resolution, and synthesizes the plurality of images to obtain a high-resolution green image; and a color synthesis processor which adjusts an optical axis of light incident to each of the red image pickup unit and the blue image pickup unit, so that both a correlation value between the high-resolution green image obtained by the high-definition synthesis processor and a red image picked up by the red image pickup unit and a correlation value between the high-resolution green image and a blue image picked up by the blue image pickup unit become a predetermined correlation value, and synthesizes the green image, the red image and the blue image to obtain a color image.

In accordance with the aspect of the present invention, the first, second and third optical systems may include a non-solid lens with a changeable refractive index distribution, and an optical axis of light incident to the image pickup element may be adjusted by changing the refractive index distribution of the non-solid lens.

In accordance with the aspect of the present invention, the non-solid lens may be a liquid crystal lens.

In accordance with the aspect of the present invention, the high-definition synthesis processor may analyze a spatial frequency of the green image obtained by synthesizing the plurality of images picked up by the plurality of green image pickup units, determines whether the power of a high spatial frequency band component is greater than or equal to a predetermined high-resolution determination threshold or not, and adjust the optical axis based on the determination result.

In accordance with the aspect of the present invention, the red image pickup unit and the blue image pickup unit may be provided between the plurality of green image pickup units.

In accordance with the aspect of the present invention, the plurality of green image pickup units, the red image pickup unit and the blue image pickup unit may be provided in a row.

In accordance with another aspect of the present invention, an imaging device including: a plurality of green image pickup units each including a first image pickup element which picks up an image of a green component and a first optical system which forms an image on the first image pickup element; a red image pickup unit including a second image pickup element which picks up an image of a red component and a second optical system which forms an image on the second image pickup element; a blue image pickup unit including a third image pickup element which picks up an image of a blue component and a third optical system which forms an image on the third image pickup element; a high-definition synthesis processor which adjusts an optical axis of light incident to the green image pickup units, so that the resolution of a green image obtained by synthesizing a plurality of images picked up by the plurality of green image pickup units becomes a predetermined resolution, and synthesizes the plurality of images to obtain a high-resolution green image; and a color synthesis processor which adjusts an optical axis of light incident to each of the red image pickup unit and the blue image pickup unit, so that both a correlation value between a green image obtained by the green image pickup unit provided between the red image pickup unit and the blue image pickup unit and a red image picked up by the red image pickup unit and a correlation value between the green image and a blue image picked up by the blue image pickup unit become a predetermined correlation value, and synthesizes the green image, the red image and the blue image to obtain a color image.

In accordance with still another aspect of the present invention, an imaging device including: a plurality of green image pickup units each including a first image pickup element which picks up an image of a green component and a first optical system which forms an image on the first image pickup element; a red and blue image pickup unit including a second image pickup element which picks up an image of a red component and an image of a blue component and a second optical system which forms an image on the second image pickup element; a high-definition synthesis processor which adjusts an optical axis of light incident to the green image pickup units, so that the resolution of a green image obtained by synthesizing a plurality of images picked up by the plurality of green image pickup units becomes a predetermined resolution, and synthesizes the plurality of images to obtain a high-resolution green image; and a color synthesis processor which adjusts an optical axis of light incident to the red and blue image pickup unit, so that both a correlation value between the high-resolution green image obtained by the high-definition synthesis processor and a red image picked up by the red and blue image pickup unit and a correlation value between the high-resolution green image and a blue image picked up by the red and blue image pickup unit become a predetermined correlation value, and synthesizes the green image, the red image and the blue image to obtain a color image.

In accordance with still another aspect of the present invention, a method of controlling an optical axis in an imaging device, including: a plurality of green image pickup units each including a first image pickup element which picks up an image of a green component and a first optical system which forms an image on the first image pickup element; a red image pickup unit including a second image pickup element which picks up an image of a red component and a second optical system which forms an image on the second image pickup element; and a blue image pickup unit including a third image pickup element which picks up an image of a blue component and a third optical system which forms an image on the third image pickup element, the method including: adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and adjusting an optical axis of light incident to each of the red image pickup unit and the blue image pickup unit, so that both a correlation value between the high-resolution green image obtained by the synthesis and a red image picked up by the red image pickup unit and a correlation value between the high-resolution green image and a blue image picked up by the blue image pickup unit become a predetermined correlation value, and synthesizing the green image, the red image and the blue image to obtain a color image.

In accordance with still another aspect of the present invention, a method of controlling an optical axis in an imaging device, including: a plurality of green image pickup units each including a first image pickup element which picks up an image of a green component and a first optical system which forms an image on the first image pickup element; a red image pickup unit including a second image pickup element which picks up an image of a red component and a second optical system which forms an image on the second image pickup element; and a blue image pickup unit including a third image pickup element which picks up an image of a blue component and a third optical system which forms an image on the third image pickup element, the method including: adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and adjusting an optical axis of light incident to each of the red image pickup unit and the blue image pickup unit, so that both a correlation value between a green image obtained by the green image pickup unit provided between the red image pickup unit and the blue image pickup unit and a red image picked up by the red image pickup unit and a correlation value between the green image and a blue image picked up by the blue image pickup unit become a predetermined correlation value, and synthesizing the green image, the red image and the blue image to obtain a color image.

In accordance with still another aspect of the present invention, a method of controlling an optical axis in an imaging device, including: a plurality of green image pickup units each including a first image pickup element which picks up an image of a green component and a first optical system which forms an image on the first image pickup element; and a red and blue image pickup unit including a second image pickup element which picks up an image of a red component and an image of a blue component and a second optical system which forms an image on the second image pickup element, the method including: adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and adjusting an optical axis of light incident to the red and blue image pickup unit, so that both a correlation value between the high-resolution green image obtained by the synthesis and a red image picked up by the red and blue image pickup unit and a correlation value between the high-resolution green image and a blue image picked up by the red and blue image pickup unit become a predetermined correlation value, and synthesizing the green image, the red image and the blue image to obtain a color image.

### Effect of the Invention

According to the present invention, it is possible to create a high-resolution full color image without color shift.

### BRIEF DESCRIPTION OF THE DRAWINGS

FIG. 1 is a perspective view showing an appearance of an imaging device in a first embodiment of the present invention.

FIG. 2 is a block diagram showing a configuration of the imaging device shown in FIG. 1.

FIG. 3 is a flowchart showing an operation of the imaging device shown in FIG. 2.

FIG. 4 is a block diagram showing a configuration of an image processor 13R shown in FIG. 2.

FIG. 5 is a diagram for explaining a process in a resolution converter 14R shown in FIG. 2.

FIG. 6 is a diagram for explaining a process in a high-resolution synthesis processor 15 shown in FIG. 2.

FIG. 7 is a diagram for explaining a process in the high-resolution synthesis processor 15 shown in FIG. 2.

FIG. 8 is a block diagram showing a configuration of the high-resolution synthesis processor 15 shown in FIG. 2.

FIG. 9 is a block diagram showing a configuration of a resolution determination controller 52 shown in FIG. 8.

FIG. 10A is a diagram for explaining a process in a resolution determination image creating unit 92 shown in FIG. 9.

FIG. 10B is another diagram for explaining the process in the resolution determination image creating unit 92 shown in FIG. 9.

FIG. 10C is another diagram for explaining the process in the resolution determination image creating unit 92 shown in FIG. 9.

FIG. 11A shows an internal shift flag of a high frequency component comparator 95 shown in FIG. 9.

FIG. 11B is a flowchart showing an operation of the high frequency component comparator 95 shown in FIG. 9.

FIG. 12 is a block diagram showing a configuration of a color synthesis processor 17 shown in FIG. 2.

FIG. 13A shows an internal shift flag of correlation detection controllers 71R and 71B shown in FIG 12.

FIG. 13B is a flowchart showing an operation of the correlation detection controllers 71R and 71B shown in FIG. 12.

FIG. 14 is a block diagram showing a configuration of an image pickup unit 10G2 shown in FIG. 2.

FIG. 15 is a diagram for explaining a configuration a liquid crystal lens 900 shown in FIG. 14.

FIG. 16A is a perspective view showing an example of the layout of image pickup units shown in FIG. 2.

FIG. 16B is a perspective view showing another example of the layout of image pickup units shown in FIG. 2.

FIG. 16C is a perspective view showing another example of the layout of image pickup units shown in FIG. 2.

FIG. 17 is a perspective view showing an appearance of an imaging device in a second embodiment of the present invention.

FIG. 18 is a block diagram showing a configuration of the imaging device shown in FIG. 17.

FIG. 19 is a flowchart showing an operation of the imaging device shown in FIG. 18.

FIG. 20 is a block diagram showing a configuration of the image pickup unit 10G2 shown in FIG. 18.

FIG. 21A is a perspective view showing an appearance of an imaging device in a third embodiment the present invention.

FIG. 21B is a perspective view showing another appearance of the imaging device in the third embodiment the present invention.

FIG. 22 is a block diagram showing a configuration of the imaging device shown in FIGS. 21A and 21B.

FIG. 23 is a flowchart showing an operation of the imaging device shown in FIG. 22.

FIG. 24 is a block diagram showing a configuration of a conventional imaging device.

FIG. 25 is a block diagram showing a configuration of another conventional imaging device.

### REFERENCE SYMBOLS

10G1, 10G2, 10G3 and 10G4: green image pickup unit, 10R: red image pickup unit, 10B: blue image pickup unit, 11: imaging lens, 12: image pickup element, 13R, 13B, 13G1, 13G2, 13G3 and 13G4: image processor, 14R and 14B: resolution converter, 15: high-resolution synthesis processor, 160 and 161: optical axis controller, and 17: color synthesis processor

### BEST MODE FOR CARRYING OUT THE INVENTION

### First Embodiment

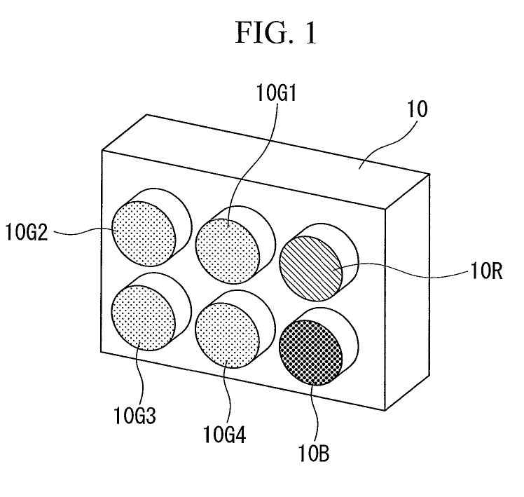

Hereinafter, an imaging device according to a first embodiment of the present invention will be described with reference to the accompanying drawings. FIG. 1 shows an appearance of the imaging device in the first embodiment. As shown in FIG. 1, in the imaging device according to the present invention, six-channel image pickup units are fixed to a substrate 10. The six-channel image pickup units include four-channel green image pickup units 10G1, 10G2, 10G3, and 10G4, a one-channel red image pickup unit 10R, and a one-channel blue image pickup unit 10B. The four-channel green image pickup units 10G1, 10G2, 10G3, and 10G4 each includes a color filter which transmits green light. The one-channel red image pickup unit 10R includes a color filter which transmits red light. The one-channel blue image pickup unit 10B includes a color filter which transmits blue light.

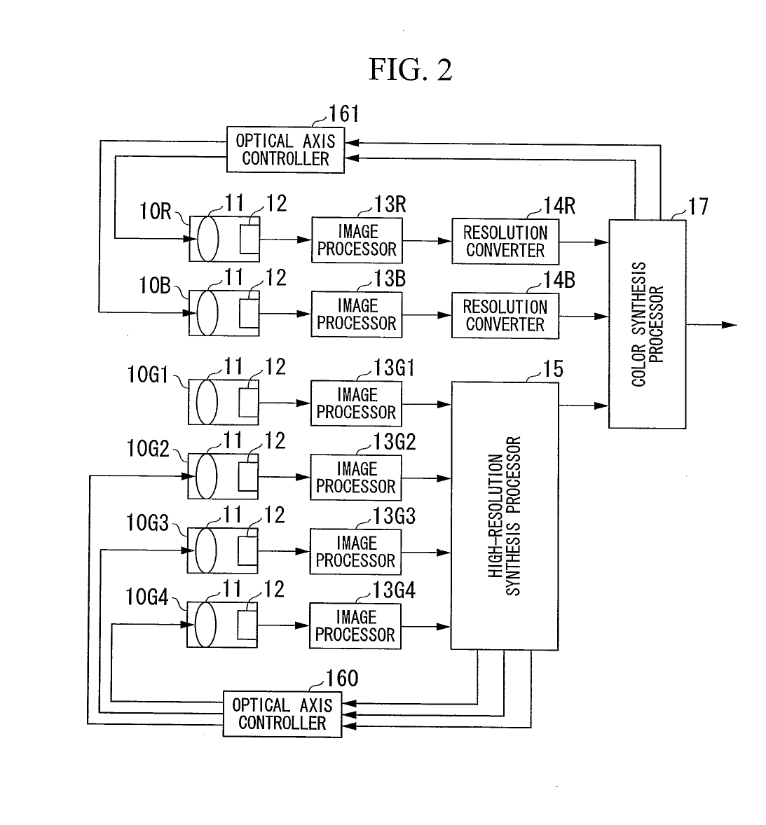

FIG. 2 is a block diagram showing a detailed configuration of the imaging device shown in FIG. 1. Each of the image pickup units 10G1, 10G2, 10G3, 10G4, 10R and 10B includes an imaging lens 11 and an image pickup element 12. The imaging lens 11 forms an image on the image pickup element 12 using light from an imaging object, and the image pickup element 12 performs photoelectric conversion on the formed image and outputs an image signal that is an electric signal. The image pickup element 12 is an application of a CMOS logic LSI manufacturing process. The image pickup element 12 is a CMOS image pickup element, which can be mass produced and has an advantage of low power consumption. A specification of the CMOS image pickup element of the present embodiment includes a pixel size of 5.6 μm×5.6 μm, a pixel pitch of 6 μm×6 μm, and an effective pixel number of 640 (horizontal)×480 (vertical), but is not particularly limited thereto. Image signals of images picked up by the six-channel image pickup units 10G1, 10G2, 10G3, 10G4, 10R, and 10B are input to respective image processors 13G1, 13G2, 13G3, 13G4, 13R, and 13B. Each of the six-channel image processors 13G1, 13G2, 13G3, 13G4, 13R, and 13B performs a correction process on the input image and outputs the resultant signal.

Each of two-channel resolution converters 14R and 14B performs resolution conversion based on an input image signal of an image. A high-resolution synthesis processor 15 receives image signals of the four-channel green images, synthesizes the four-channel image signals, and outputs an image signal of a high resolution image. A color synthesis processor 17 receives red and blue image signals from the two-channel resolution converters 14R and 14B and the green image signal from the high-resolution synthesis processor 15, synthesizes the image signals, and outputs a high-resolution color image signal. An optical axis controller 160 analyzes an image signal obtained by synthesizing the image signals of the four-channel green images, and performs control to adjust incident optical axes of the three-channel image pickup units 10G2, 10G3 and 10G4, so that a high-resolution image signal is obtained, based on the analysis result. An optical axis controller 161 analyzes an image signal obtained by synthesizing the image signals of the three-channel images (red, blue and green), and performs control to adjust incident optical axes of the two-channel image pickup units 10R and 10B so that the high-resolution image signal is obtained, based on the analysis result.

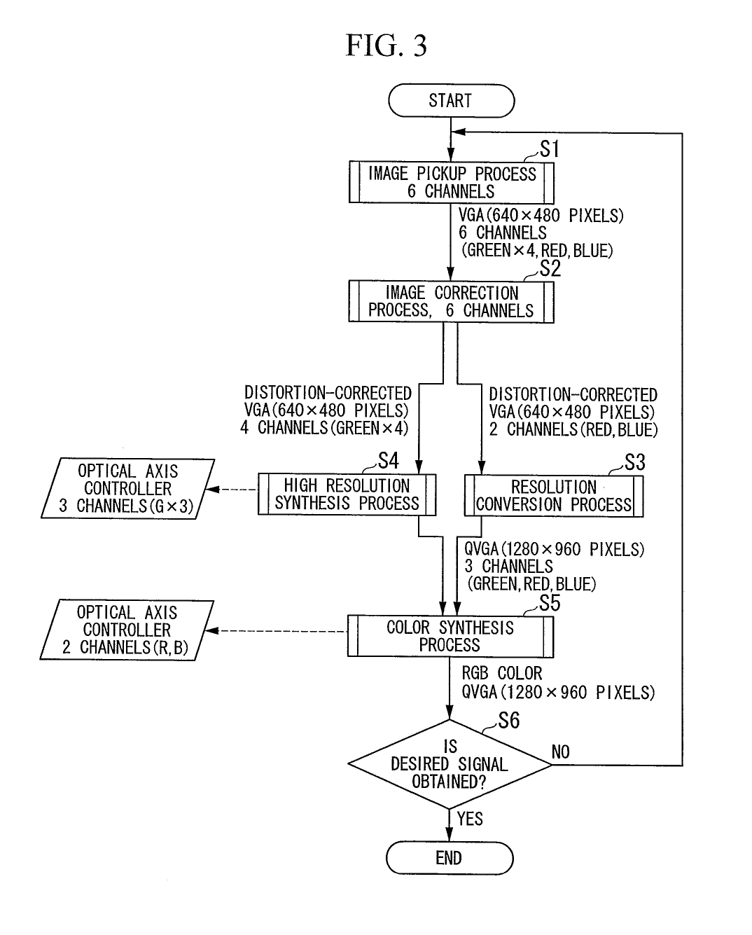

Next, an operation of the imaging device shown in FIG. 2 will be described with reference to FIG. 3. FIG. 3 is a flowchart showing the operation of the imaging device shown in FIG. 2. First, each of the six-channel image pickup units 10G1, 10G2, 10G3, 10G4, 10R, and 10B picks up an image of an object, and outputs an obtained image signal (VGA 640×480 pixels) (step S1). The six-channel image signals are input to the six-channel image processors 13G1, 13G2, 13G3, 13G4, 13R, and 13B. Each of the six-channel image processors 13G1, 13G2, 13G3, 13G4, 13R, and 13B performs an image correction process, i.e., a distortion correction process, on the input image signal and outputs the resultant signal (step S2).

Next, each of the two-channel resolution converters 14R and 14B performs a process of converting the resolution of the input distortion-corrected image signal (VGA 640×480 pixels) (step S3). Through this process, the two-channel image signals are converted into image signals with quad-VGA 1280×960 pixels. Meanwhile, the high-resolution synthesis processor 15 performs a process for synthesizing the input distortion-corrected four-channel image signals (VGA 640×480 pixels) to achieve high resolution (step S4). Through the synthesis process, the four-channel image signals are synthesized and an image signal with quad-VGA 1280×960 pixels is output. In this case, the high-resolution synthesis processor 15 analyzes an image signal obtained by synthesizing the image signals of the four-channel green images, and outputs a control signal to the optical axis controller 160 so that the optical axis controller 160 performs control to adjust the incident optical axes of the three-channel image pickup units 10G2, 10G3 and 10G4 such that the high-resolution image signal is obtained, based on the analysis result.

Next, the color synthesis processor 17 receives the three-channel image signals (quad-VGA 1280×960 pixels) (red, blue, and green), synthesizes the three-channel image signals, and outputs an RGB color image signal (quad-VGA 1280×960 pixels) (step S5). In this case, the color synthesis processor 17 analyzes an image signal obtained by synthesizing three-channel image signals (red, blue, and green), and outputs a control signal to the optical axis controller 161 so that the optical axis controller 161 performs control to adjust incident optical axes of the two-channel image pickup units 10R and 10B such that the high-resolution image signal is obtained, based on the analysis result. The color synthesis processor 17 determines whether a desired RGB color image signal is obtained or not, repeatedly performs the process until the desired RGB color image signal is obtained (step S6), and terminates the process when the desired RGB color image signal is obtained.

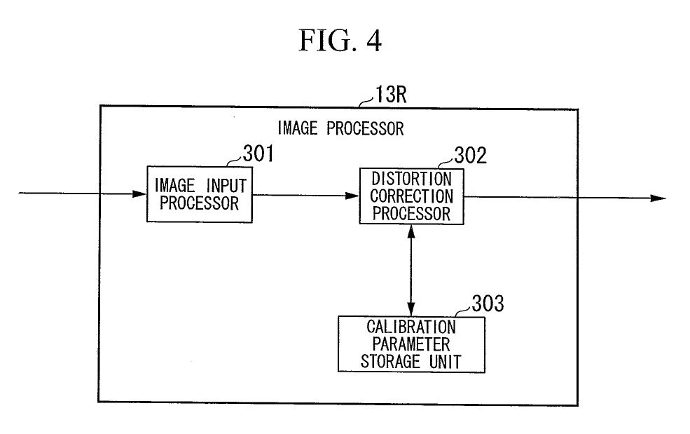

Next, a detailed configuration of the image processor 13R shown in FIG. 2 will be described with reference to FIG. 4. Since six-channel image processors 13G1, 13G2, 13G3, 13G4, 13R, and 13B shown in FIG. 2 have the same configuration, a detailed configuration of the image processor 13R will be described herein and a description of detailed configurations of the five image processors 13G1, 13G2, 13G3, 13G4 and 13B will be omitted. The image processor 13R includes an image input processor 301 which receives the image signal, a distortion correction processor 302 which performs a distortion correction process on the input image signal, and a calibration parameter storage unit 303 which stores a calibration parameter for distortion correction in advance. The image signal output from the image pickup unit 10R is input to the image input processor 301 and subjected to, for example, a knee process, a gamma process, and a white balance process.

Subsequently, the distortion correction processor 302 performs an image distortion correction process on the image signal output from the image input processor 301 based on the calibration parameter stored in the calibration parameter storage unit 303. The calibration parameters stored in the calibration parameter storage unit 303 include image center position information, a scale factor that is a product of pixel size and the focal length of an optical lens, and distortion information for a coordinate axis of an image, which are called internal parameters of a pinhole camera model. A geometric correction process is performed according to the calibration parameters to correct distortion such as distortion aberrations of the imaging lens. The calibration parameters may be measured at a factory and stored in the calibration parameter storage unit 303 in advance, or may be calculated from an image obtained by picking up a checker pattern, of which the pattern shape is known, several times while changing the attitude or angle of the pattern. Image distortions specific to the respective image pickup units 10G1, 10G2, 10G3, 10G4, 10R, and 10B are corrected by the six-channel image processors 13G1, 13G2, 13G3, 13G4, 13R, and 13B.

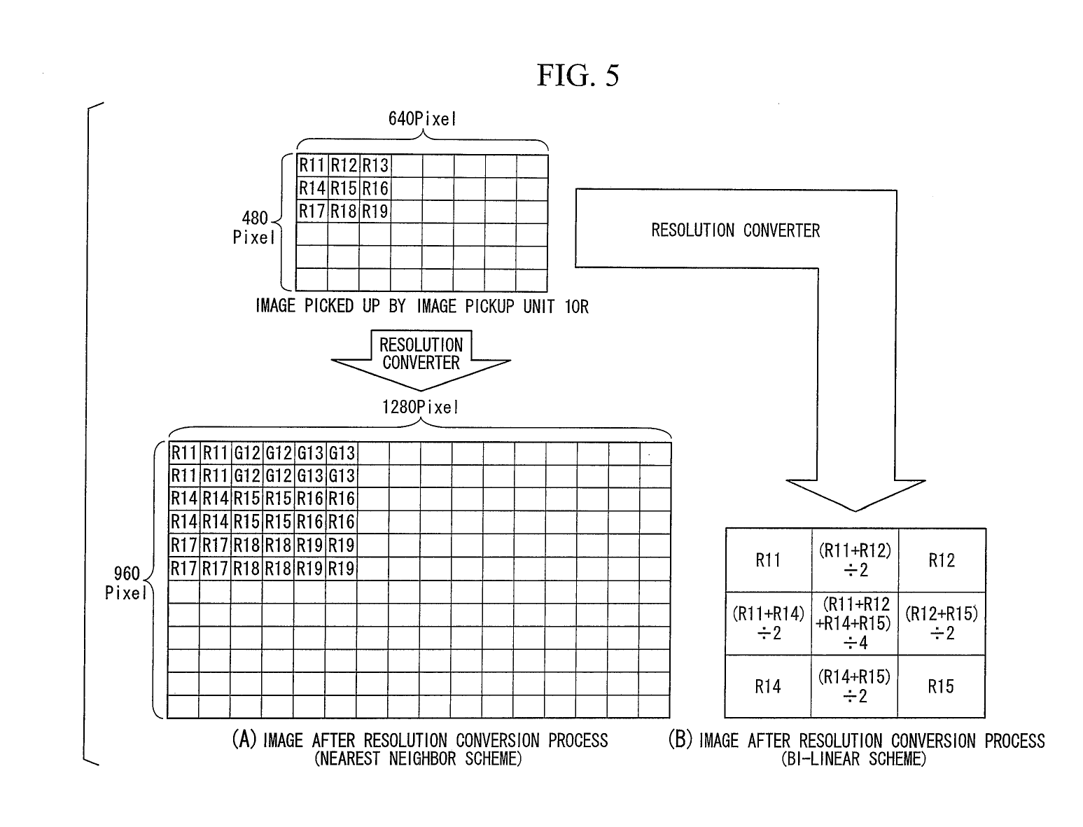

Next, a detailed operation of the resolution converter 14R shown in FIG. 2 will be described with reference to FIG. 5. Since the resolution converters 14R and 14B shown in FIG. 2 perform the same process, an operation of the resolution converter 14R will be described herein and a description of an operation of the resolution converter 14B will be omitted. The resolution converter 14R converts the input red image signal from a VGA image resolution to a quad-VGA image resolution. A known processing scheme may be used to convert the input red image from a VGA image (640×480 pixels) to a quad-VGA image (1280×960 pixels). For example, a nearest neighbor scheme of simply copying one original pixel to obtain four pixels as shown in FIG. 5(A), a bi-linear scheme of creating surrounding pixels from four peripheral pixels through linear interpolation as shown in FIG. 5(B), or a bi-cubic scheme (not shown) of performing interpolation from 16 surrounding pixels using a third-order function may be used. The distortion-corrected red image signal is converted from a VGA image resolution to a quad-VGA image resolution by the resolution converter 14R. Similarly, the blue image signal, which has been subjected to distortion correction, is converted from the VGA image resolution to the quad-VGA image resolution by the resolution converter 14B.

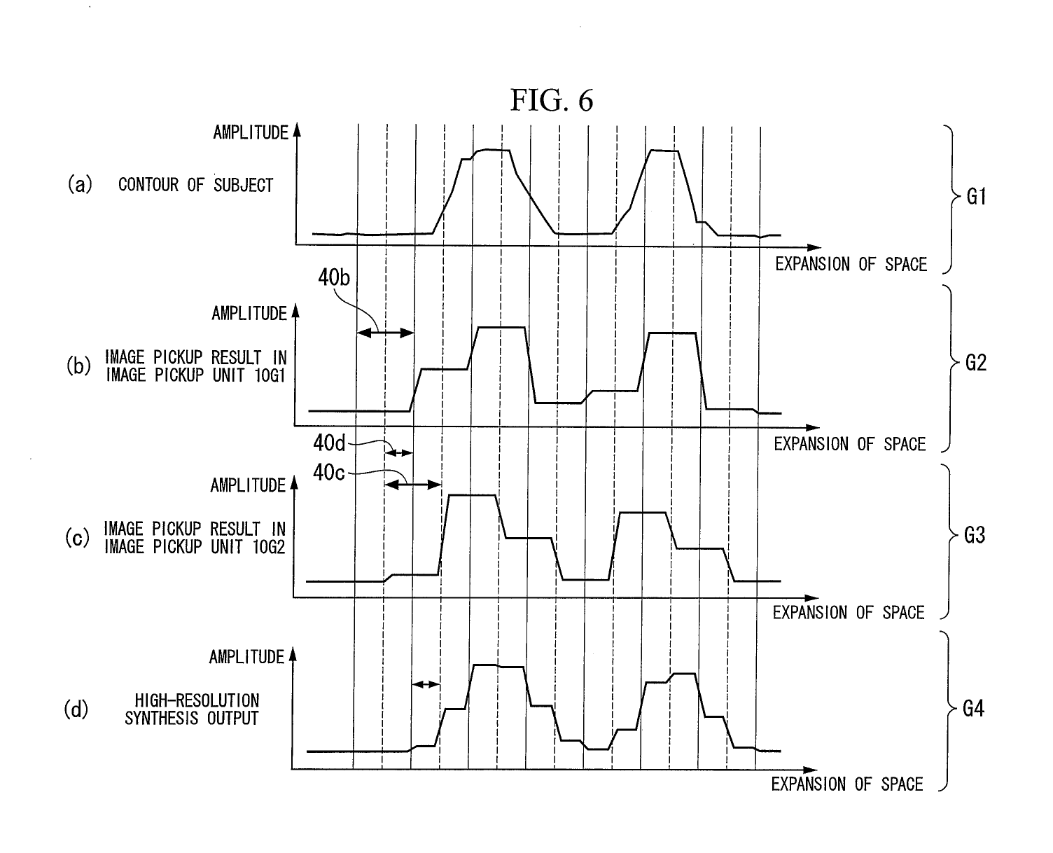

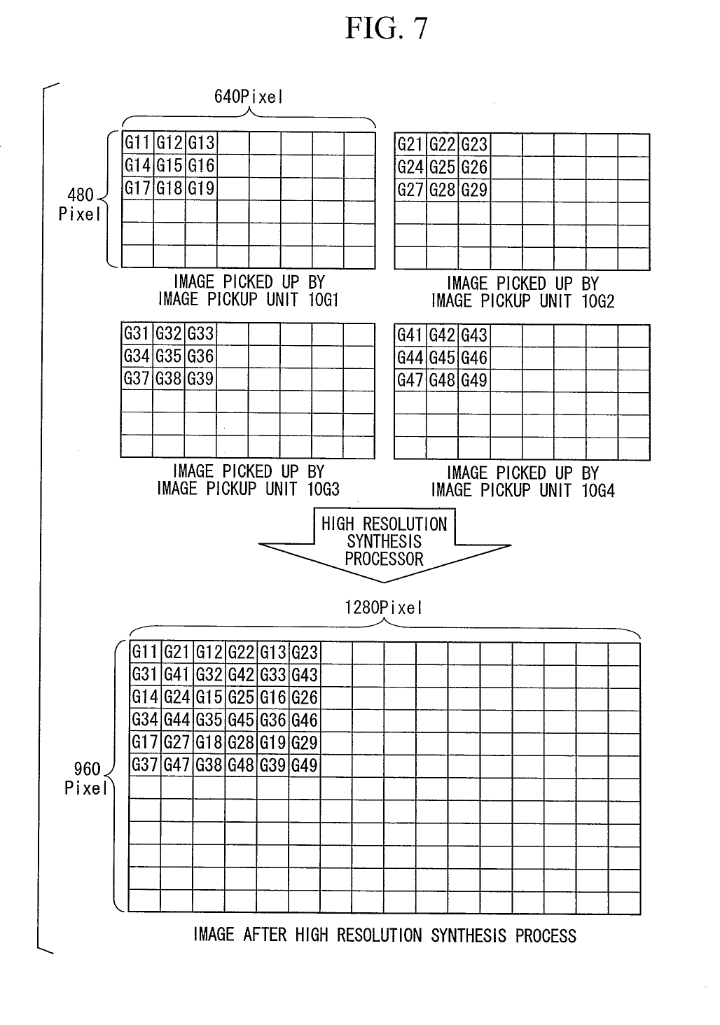

Next, a process in the high-resolution synthesis processor 15 shown in FIG. 2 will be described with reference to FIGS. 6 and 7. The high-resolution synthesis processor 15 synthesizes the four-channel image signals picked up by the image pickup units 10G1, 10G2, 10G3, and 10G4 to obtain one high resolution image. A synthesis scheme will be described with reference to schematic diagrams shown in FIGS. 6 and 7. In FIG. 6, a horizontal axis denotes an expansion (size) of a space and a horizontal axis denotes the intensity of light. In order to simplify the description, a high-resolution synthesis process using two images picked up by the two image pickup units 10G1 and 10G2 will be described herein. In FIG. 6, arrows 40b and 40c indicate pixels of the image pickup units 10G1 and the image pickup unit 10G 2, respectively and it is assumed that a relative position is shifted by an offset amount 40d. In order to integrate the light intensity in units of pixels, the image pickup element 12 may obtain an image signal with a light intensity distribution shown in a graph G2 when a contour (a) of a subject shown in a graph G1 is picked up by the image pickup element 10G1, and an image signal with a light intensity distribution shown in a graph G3 when the subject contour is picked up by the image pickup element 10G2. The two images may be synthesized to reproduce a high resolution image close to an actual contour as shown in a graph G4.

The high-resolution synthesis process using the two images has been described with reference to FIG. 6. The high-resolution synthesis process using VGA (640×480 pixels) images obtained by the four image pickup units 10G1, 10G2, 10G3, and 10G4 shown in FIG. 2 will now be described with reference to FIG. 7. In order to obtain quad-VGA pixels (1280×960 pixels), which are quadruple VGA pixels (640×480 pixels), the high-resolution synthesis processor 15 assigns pixels picked up by the different image pickup units to four adjacent pixels and synthesizes the pixels. Thus, it is possible to obtain a high resolution image using four image pickup elements each capable of obtaining a VGA (640×480 pixels) image. For example, four pixels including a pixel G15 of the image picked up by the image pickup unit 10G1 and corresponding pixels G25, G35 and G45 picked up by the image pickup units 10G2, 10G3 and 10G4, respectively, are taken as surrounding images after the high-resolution synthesis process.

The effect of the high-resolution synthesis process greatly depends on the offset amount 40d shown in FIG. 6. As shown in the schematic diagram of FIG. 6, the offset amount 40d is ideally set as a ½ pixel size. However, it is difficult to consistently maintain the offset amount of the ½ pixel size, due to a change of a focal length, assembly precision, aging and so on. Accordingly, in the present invention, the resolution of the high resolution image is compared with a predetermined threshold and the optical axis of each image pickup unit is shifted according to the comparison result to maintain an ideal offset.

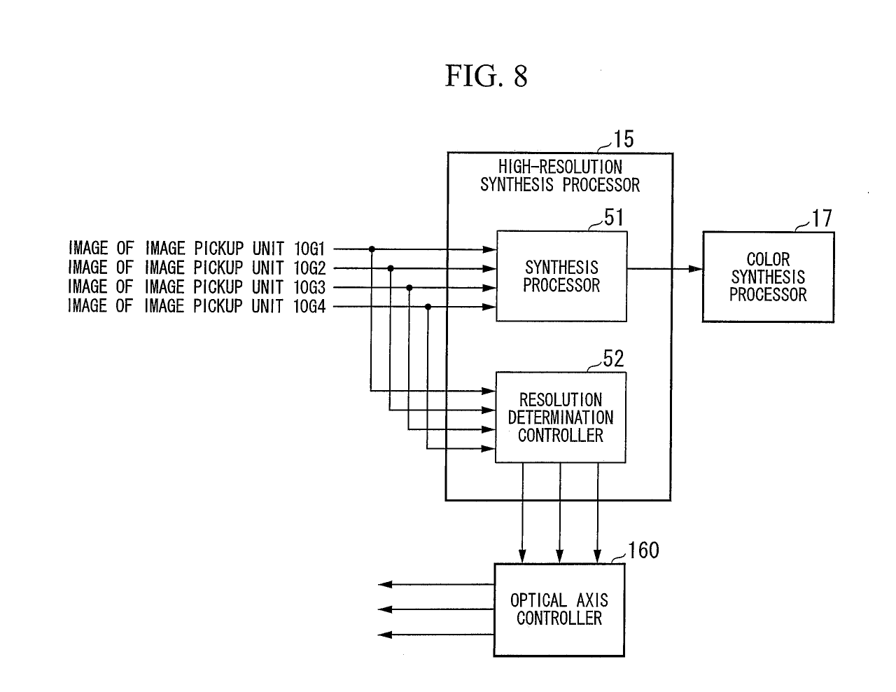

Next, an optical axis shift control in the high-resolution synthesis processor 15 will be described with reference to FIG. 8. FIG. 8 is a block diagram showing a detailed configuration of the high-resolution synthesis processor 15 shown in FIG. 2.

The image synthesis processor 15 includes a synthesis processor 51 which synthesizes four image signals picked up by the image pickup units 10G1, 10G2, 10G3, and 10G4 into one high definition image signal (the process in FIG. 7) and outputting the high definition image signal to the color synthesis processor 17, and a resolution determination controller 52 which outputs a control signal for controlling the shift of optical axes of the image pickup units 10G2, 10G3 and 10G4 to the optical axis controller 160 so that the synthesized image output from the synthesis processor 51 has a good resolution.

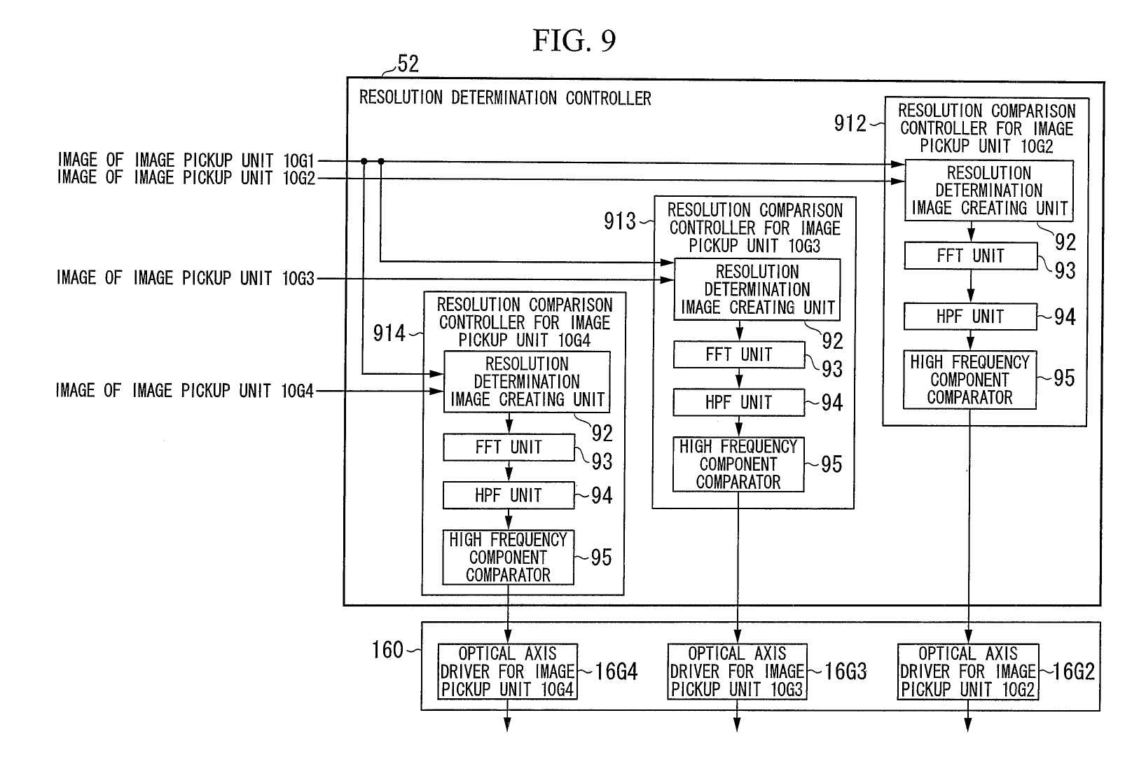

Next, a detailed configuration of the resolution determination controller 52 shown in FIG. 8 will be described with reference to FIG. 9. As shown in FIG. 9, the resolution determination controller 52 includes three resolution comparison controllers 912, 913 and 914 for the three image pickup units 10G2, 10G3, and 10G4. Each of the resolution comparison controllers 912, 913, and 914 includes a resolution determination image creating unit 92 which creates an image for determining resolution from two input images, a fast Fourier transform (FFT) unit 93 which converts the generated resolution determination image into a spatial frequency component through an FFT process, a high pass filter (HPF) unit 94 which detects the power (power value) of a high spatial frequency band from the spatial frequency component, and a high frequency component comparator 95 which compares the detected power of the high spatial frequency band component with a threshold and controls an optical-axis shift direction to obtain the highest resolution.

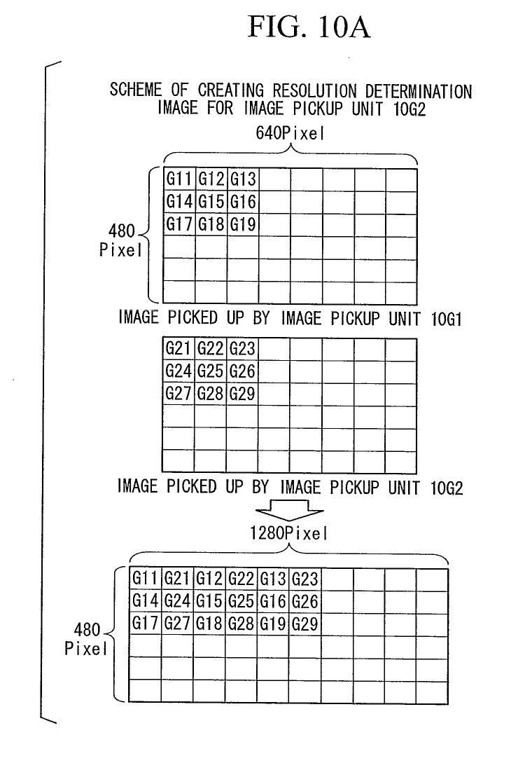

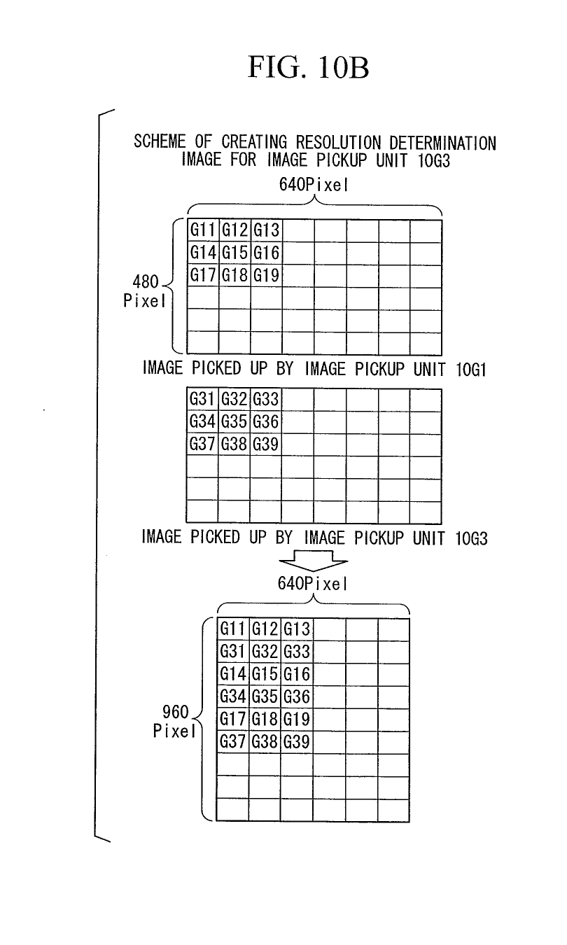

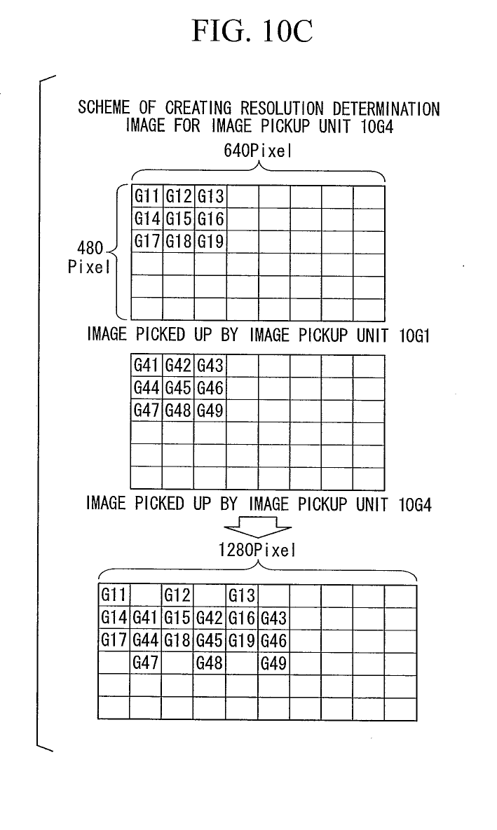

Images created by three resolution determination image creating units 92 are shown in FIGS. 10A, 10B and 10C. The resolution determination image is created by combining an image picked up by the image pickup unit 10G1, which is a basic image, with the images picked up by the image pickup units 10G2, 10G3 and 10G4, by means of the layout using the synthesis scheme in the high-resolution synthesis process of FIG. 7. The power of the high spatial frequency band component of each resolution determination image is detected by the FFT unit 93 and the HPF unit 94, and a control signal for controlling the shift of respective optical axes of the image pickup units 10G2, 10G3 and 10G4 based on the detection result is output to the optical axis controller 160, so that the images picked up by the respective image pickup units maintain an ideal offset.

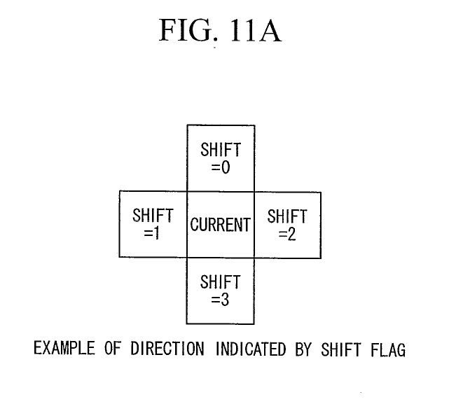

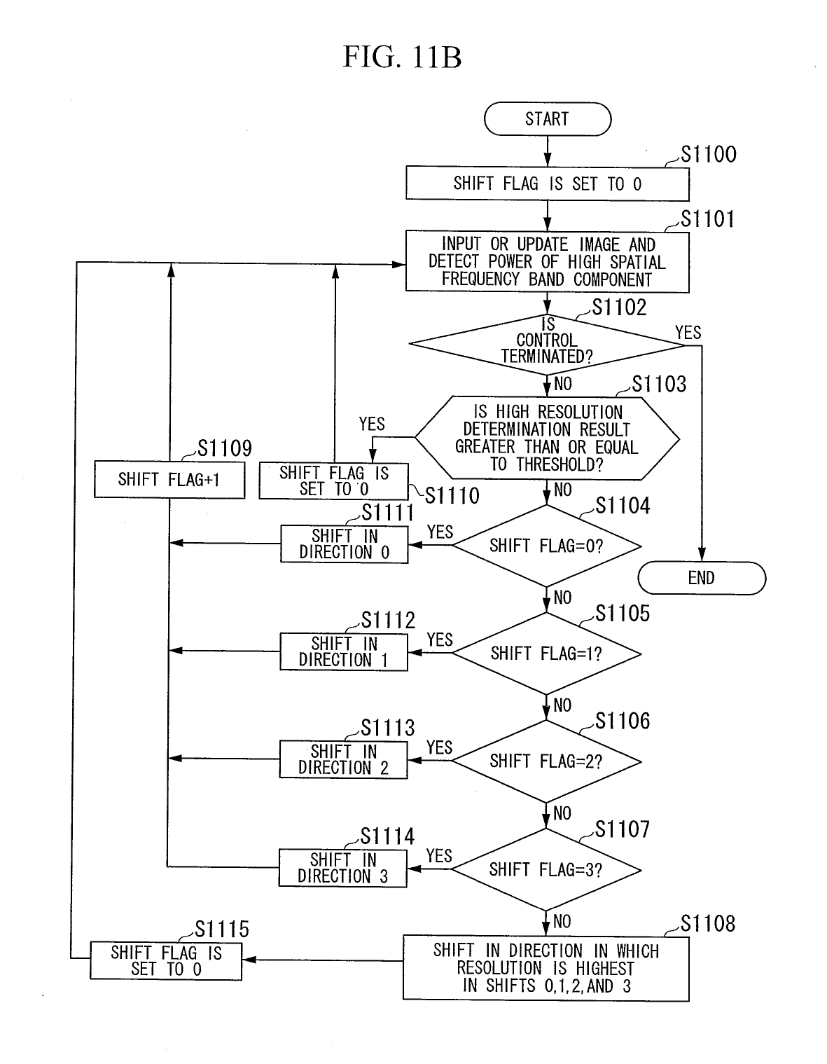

An optical-axis shift control process in the high frequency component comparator 95 will now be described with reference to FIG. 11B. The high frequency component comparator 95 has an internal shift flag indicating a shift direction as shown in FIG. 11A. When the optical axis is shifted in an up direction from a current position, the shift flag is set to 0, when the optical axis is shifted in a down direction, the shift flag is set to 3, when the optical axis is shifted in a left direction, the shift flag is set to 1, and when the optical axis is shifted in a right direction, the shift flag is set to 2.

First, the high frequency component comparator 95 initializes the shift flag to 0 (step S1100). Subsequently, when the image is input or updated, the resolution determination images shown in FIGS. 10A, 10B, and 10C are created, and the powers of the high spatial frequency band components are detected (step S1101). A determination is made as to whether the power of the high spatial frequency band component is greater than or equal to the predetermined threshold or not, i.e., whether the image has a high resolution or not (step S1103). When the image has a high resolution, the shift flag is initialized without optical axis shift (step S1110) and the process is repeated.

On the other hand, when the power of the high spatial frequency band component is smaller than the threshold and the image has a low resolution, the optical axis is shifted by a predetermined amount in the direction indicated by the shift flag (steps S1104 to S1107 and steps S1111 to S1114), and the shift flag value is incremented, i.e., 1 is added to the shift flag value (step S1109). When the power of the high spatial frequency band component is greater than or equal to the threshold in any of the optical axis shifts 0, 1, 2, and 3, the shift flag is initialized at the optical axis shift state and a loop is repeated. On the other hand, when the power is smaller than the threshold in the optical axis shifts 0, 1, 2, and 3, the optical axis is shifted by a predetermined amount in a direction in which the resolution is highest in the optical axis shifts 0, 1, 2, and 3 (step S1108). The shift flag is then initialized (step S1115), and the process is repeated until the control termination is determined (step S1102). Through this process, the control signal for controlling the optical axis shift so that the synthesized image has a resolution greater than or equal to the threshold or the highest resolution is output to the optical axis controller 160.

The threshold is fixed, but may be adaptively changed according to, for example, a previous determination result (step S1103).

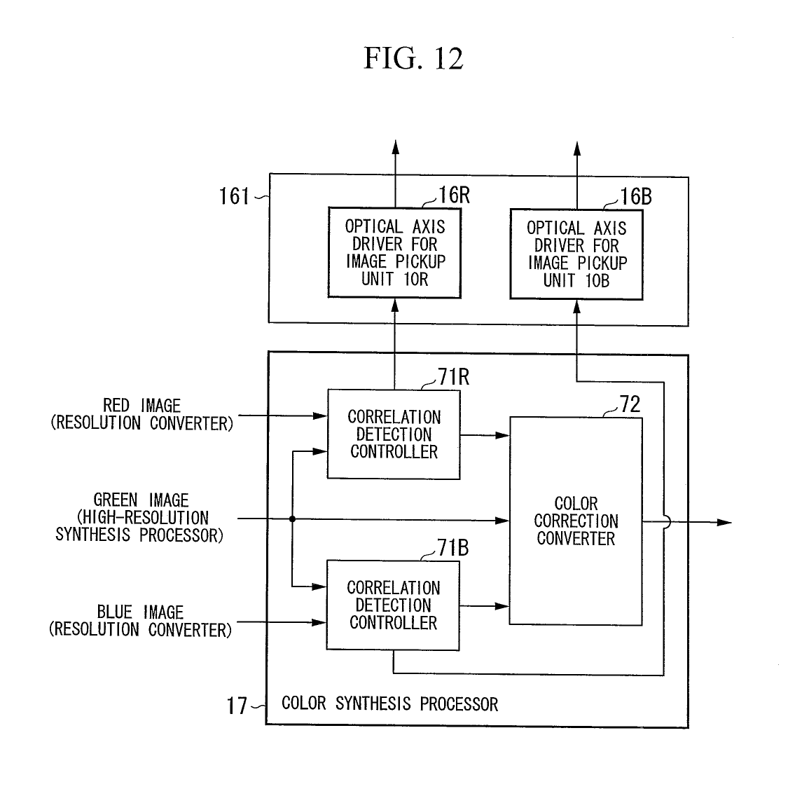

Next, a detailed configuration and a processing operation of the color synthesis processor 17 shown in FIG. 2 will be described with reference to FIG. 12. The color synthesis processor 17 synthesizes the red image signal and the blue image signal expanded into quad-VGA resolution by the two-channel resolution converters 14R and 14B and the green image signal subjected to the high-resolution synthesis process for quad-VGA by the high-resolution synthesis processor 15, and outputs a full color quad-VGA image. The color synthesis processor 17 includes two correlation detection controllers 71R and 71B which calculate a correlation value of two input images and performs control so that the two images have a high correlation value. Since the same subject is picked up at the same time, the input red, blue and green image signals have a high correlation. The correlation is monitored to correct a relative shift between the red, green and blue images. Herein, positions of the red image and the blue image are corrected using the image signal of the green image subjected to high resolution process synthesis as a reference.

A concrete example of a scheme of calculating a correlation value between images will be described. A function of the green image is G(x, y), and a function of the red image is R(x, y). The functions are subjected to Fourier transform to obtain a function G (ξ, η) and a function R (ξ, η). From the functions, a correlation value Cor between the green image and the red image is represented by the following equation:

$$Cor = \frac{R ( ξ , η )}{\vert R ( ξ , η ) \vert} \cdot \frac{G * ( ξ , η )}{\vert G ( ξ , η ) \vert} \qquad [ Equation 1 ]$$

where * indicates a conjugate relation.

The correlation value Cor ranges from 0 to 1.0. As the value approaches 1.0, the correlation is high and as the values approaches 0, the correlation is low. The control is performed so that the correlation value Cor is greater than or equal to, for example, 0.9, which is a predetermined value, to correct a relative position shift between the red image and the green image.

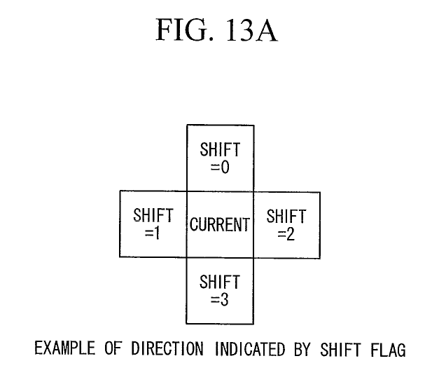

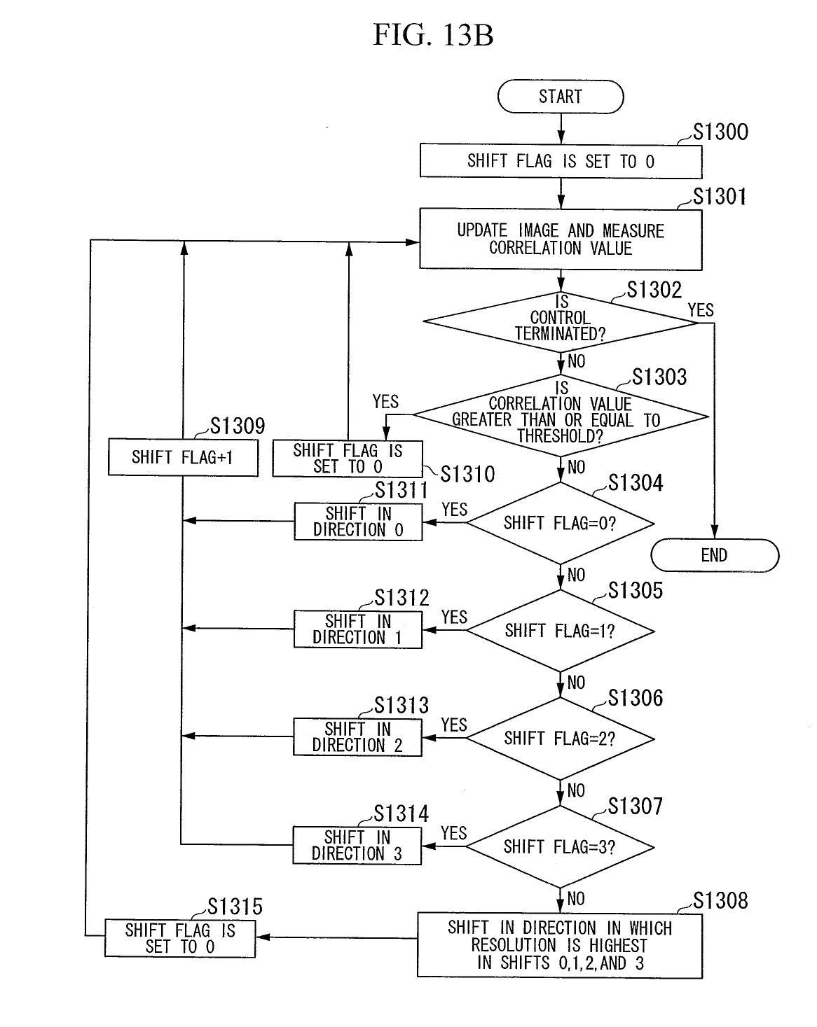

Here, a control process of correcting the relative position shift between the red image and the green image in the correlation detection controller 71R will be described with reference to FIG. 13B. The correlation detection controller 71R has an internal shift flag indicating a shift direction as shown in FIG. 13A. When the optical axis is shifted in an up direction from a current position, a shift flag is set to 0, when the optical axis is shifted in a down direction, the shift flag is set to 3, when the optical axis is shifted to a left direction, the shift flag is set to 1, and when the optical axis shifted to the right, the shift flag is set to 2.

First, the correlation detection controller 71R initializes the shift flag (step S1300).

Subsequently, when an image is input or updated, a correlation value Cor is calculated (step S1301). A determination is made to as to whether the correlation value Cor is greater than or equal to a predetermined threshold or not (step S1303). When the correlation value Cor is greater than or equal to the predetermined threshold, the shift flag is initialized without optical axis shift and a loop is repeated (step S1310).

On the other hand, when the correlation value Cor is smaller than the threshold, the optical axis is shifted a predetermined amount in the direction indicated by the shift flag (steps S1103 to S1107 and steps S1311 to S1314). The shift flag is then incremented by 1 (step S1309), and the process is repeated. When the correlation value Cor is greater than or equal to the threshold in any of the optical axis shifts 0, 1, 2, and 3, the shift flag is initialized at the optical axis shift state and a loop is repeated. On the other hand, when the correlation value Cor is smaller than the threshold in any of the optical axis shifts 0, 1, 2, and 3, the optical axis is shifted a predetermined amount in direction in which the resolution is highest in the optical axis shifts 0, 1, 2, and 3 (step S1308), and the shift flag is initialized (step S1315). Through this process, a control signal for controlling the optical axis shift to make the correlation value of the red image, green image, and blue image greater than or equal to a threshold, i.e., to minimize the shift amount is output to the optical axis controller 161. An operation of the correlation detection controller 71B shown in FIG. 12 is the same as shown in FIGS. 13A and 13B.

Thus, the shift-corrected red, green, and blue images are output to the color correction converter 72, which converts the images into one full color image and outputs the full color image. A known scheme may be used to convert the images into the full color image. For example, respective 8-bit data of the input red, green, and blue images may be combined into three layers and converted into RGB 24-bit (3×8 bits) color data that can be displayed on a display unit. In order to improve color rendering in the color correction conversion process, a color correction process using, for example, a 3×3 color conversion matrix or a look up table (LUT), may be performed.

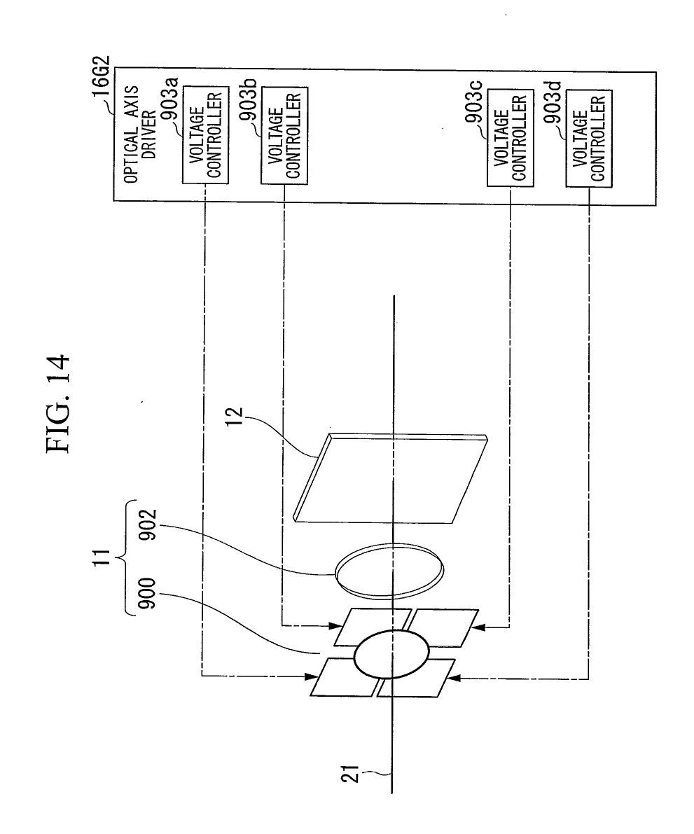

As shown in FIGS. 9 and 12, the outputs of the three high frequency component comparators 95 and the two correlation detectors 71R and 71B are output to the respective optical axis driver 16G2, 16G3, 16G4, 16R, and 16B for the five image pickup units 10G2, 10G3, 10G4, 10R, and 10B to control a shift amount of an optical axis of a liquid crystal lens constituting the imaging lens 11 of the image pickup units 10G2, 10G3, 10G4, 10R, and 10B. An optical axis shift operation will now be described using a concrete example with reference to FIGS. 14 and 15. As shown in FIG. 14, the imaging lens 11 includes a liquid crystal lens 900 and an optical lens 902. Four-channel voltages are applied to the liquid crystal lens 900 by four voltage controllers 903a, 903b, 903c, and 903d in an optical axis driver (corresponding to the optical axis driver 16G2 in case of the image pickup unit 10G2) and the optical axis shift is controlled. The liquid crystal lens 900 includes a glass layer 1000, a first transparent electrode layer 1003, an insulating layer 1007, a second electrode layer 1004, an insulating layer 1007, a liquid crystal layer 1006, a third transparent electrode layer 1005, and a glass layer 1000 from the top (an imaging object side), as shown in a cross-sectional view of FIG. 15. The second electrode 1004 includes a circular hole 1004E, and four electrodes 1004a, 1004b, 1004c and 1004d to which voltages from the respective voltage controllers 903a, 903b, 903c and 903d can be individually applied.

A predetermined alternating voltage 1010 is applied between the first transparent electrode 1003 and the third transparent electrode 1005 and a predetermined alternating voltage 1011 is applied between the second electrode 1004 and the third transparent electrode 1005, such that an electric field gradient is formed as an object using the center of the circular hole 1004E of the second electrode 1004 as an axis. The electric field gradient aligns liquid crystal molecules in the liquid crystal layer 1006 to change a refractive index distribution of the liquid crystal layer 1006 from the center of the hole 1004E to a peripheral side, such that the liquid crystal layer 1006 serves as a lens. When the same voltages are applied to the electrodes 1004a, 1004b, 1004c, and 1004d of the second electrode 1004, the liquid crystal layer 1006 forms a spherical lens of a center axis object. On the other hand, when different voltages are applied, the refractive index distribution is changed and a lens with a shifted optical axis is formed. As a result, it is possible to shift the optical axis incident to the imaging lens 11.

For example, an example of optical axis control in the optical axis driver 16G2 will be described. At a state of a convex lens with the center of the hole 1004E as an axis where an alternating voltage of 20 Vrms is applied between the electrode 1003 and the electrode 1005 and the same alternating voltages of 70 Vrms are applied to the electrode 1004a, 1004b, 1004c, and 1004d, the voltages applied to the electrodes 1004b and 1004d are changed into 71 Vrms to shift the optical axis by 3 μm corresponding to a ½ pixel size from the center of the hole 1004E.

Although the example in which the liquid crystal lens is used as a means which shifts the optical axis has been described, other means may be used. For example, a scheme of controlling a refraction plate or a variable angle prism using an actuator may be used, in which the whole or a portion of the optical lens 902 is moved by the actuator and the image pickup element 12 is moved by the actuator.

It is possible to realize a multi-view color imaging device including the six-channel image pickup units 10G1, 10G2, 10G3, 10G4, 10R, and 10B in order to increase the resolution and performing the optical axis shift control so that the images of the respective image pickup units have a proper position relationship, using the high-resolution synthesis processor 15 and the color synthesis processor 17, as described above.

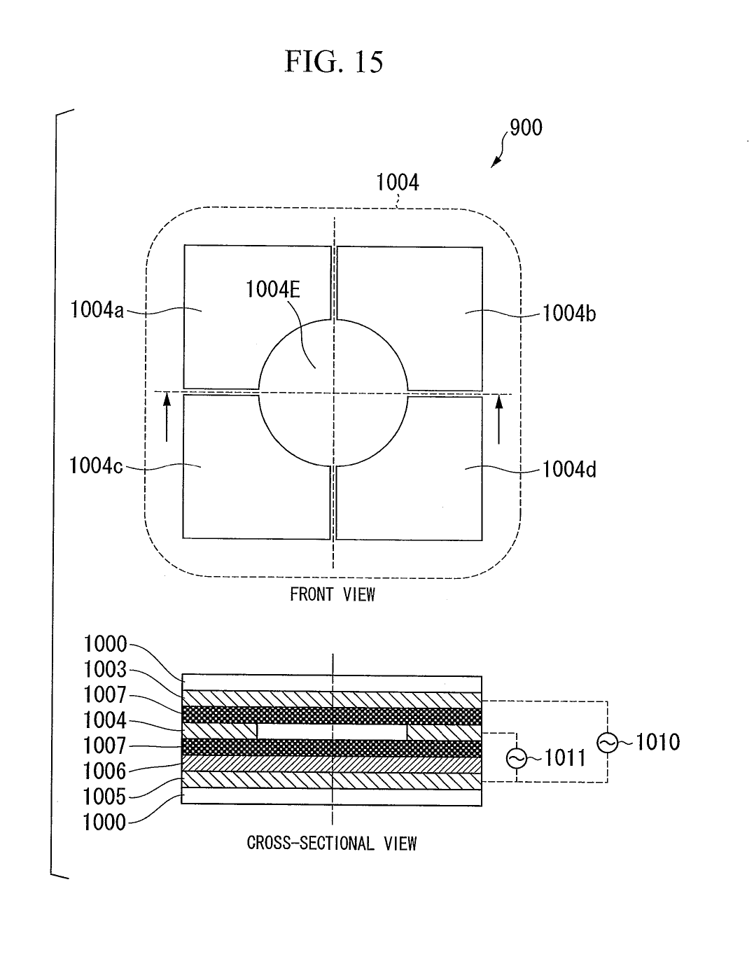

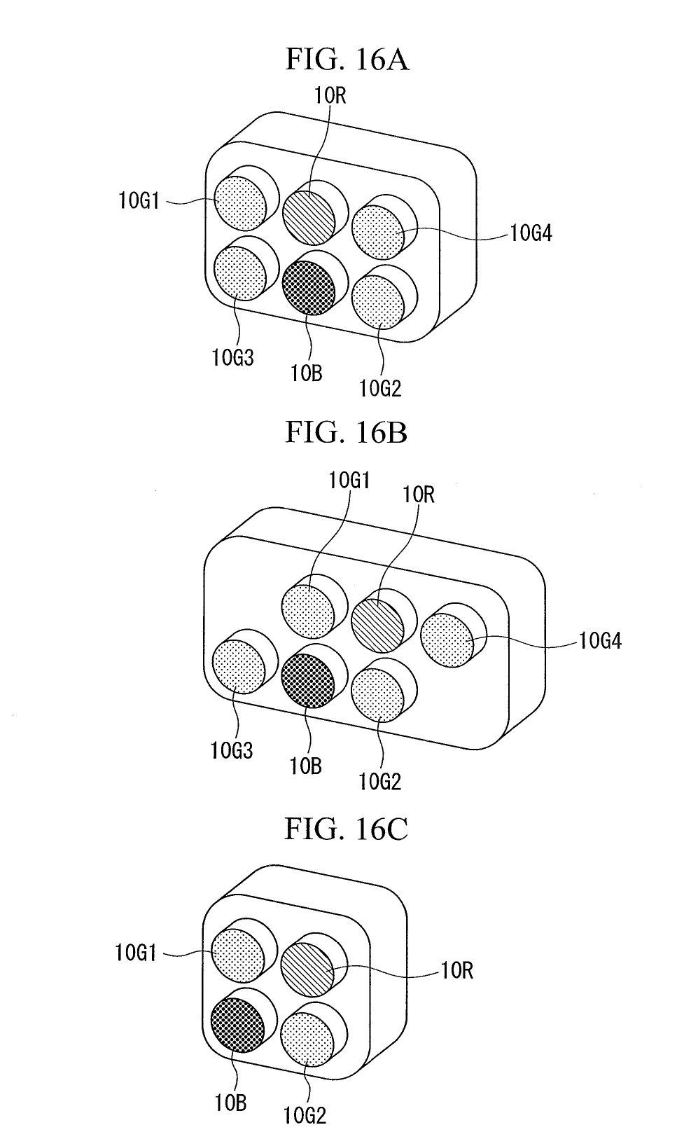

The six-channel image pickup units 10G1, 10G2, 10G3, 10G4, 10R, and 10B shown in FIG. 2 are not limited to the layout of FIG. 1, but variations may be made to the layout. Several examples are shown in FIGS. 16A, 16B and 16C. In FIG. 16A, the red image pickup unit 10R and the blue image pickup unit 10B are provided at the center of the device. According the layout of FIG. 16A, the green image pickup units 10G1, 10G2, 10G3 and 10G4, the red image pickup unit 10R, and the blue image pickup unit 10B are closer to one another, such that the color shift can be reduced and a load of the color synthesis processor 17 can be reduced. In FIG. 16B, the red image pickup unit 10R and the blue image pickup unit 10B are provided diagonally. In the layout, the optical axis shift control is performed using the green image pickup units 10G1 and 10G2, the red image pickup units 10R, and the blue image pickup unit 10B, which form a Bayer layout, as a reference, thereby increasing a color shift reduction effect. Alternatively, the imaging device may include the four image pickup units 10G1, 10G2, 10R, and 10B without the green image pickup units 10G3 and 10G4 at both ends in FIG. 16B, as shown in FIG. 16C.

### Second Embodiment

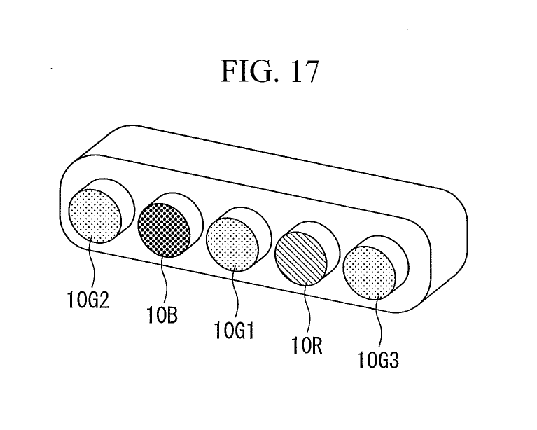

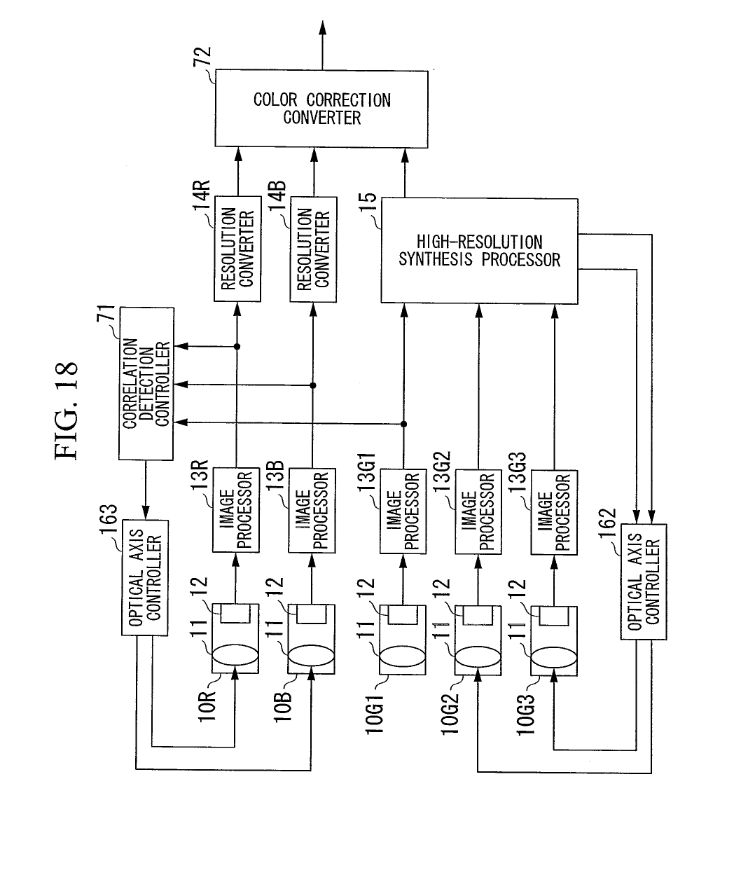

Next, an imaging device according to a second embodiment of the present invention will be described with reference to the accompanying drawings. FIG. 17 shows an appearance of the imaging device in the second embodiment. Since the imaging device in the second embodiment includes three green image pickup units 10G1, 10G2, and 10G3, a red image pickup unit 10R, and a blue image pickup unit 10B provided in a row, as shown in FIG. 17, an elongated design can be obtained, unlike the first embodiment. A configuration of the imaging device in the second embodiment will be described with reference to FIG. 18.

The imaging device shown in FIG. 18 differs from the imaging device shown in FIG. 2 in that there are three green image pickup units and that correlation detection control is performed to correct a color shift in a previous stage of resolution converters 14R and 14B and a high-resolution synthesis processor 15. Since the green image pickup unit 10G1 is provided at the center of the three green image pickup units and is also provided at the center of the red, green and blue image pickup units as shown in FIG. 17, the color shift correction in the previous stage of the resolution converter 14 and the high-resolution synthesis processor 15 does not cause problems. Furthermore, it is possible to reduce a processing amount in comparison with the first embodiment since the correlation value is calculated at a lower resolution.

A configuration of the imaging device in the second embodiment will be described with reference to FIG. 1. Each of the image pickup units 10G1, 10G2, 10G3, 10R, and 10B includes an imaging lens 11 and an image pickup element 12. The imaging lens 11 forms an image on the image pickup element 12 using light from an object, and the image pickup element 12 performs photoelectric conversion on the formed image to output an image signal. The image pickup element 12 is a low-power CMOS image pickup element. A specification of the CMOS image pickup element of the present embodiment includes a pixel size of 5.6 μm×5.6 μm, a pixel pitch of 6 μm×6 μm, and an effective pixel number of 640 (horizontal)×480 (vertical), but is not particularly limited thereto. Image signals of the images picked up by the five-channel image pickup units 10G1, 10G2, 10G3, 10R and 10B are respectively input to image processors 13G1, 13G2, 13G3, 13R, and 13B. Each of the five-channel image processors 13G1, 13G2, 13G3, 13R and 13B performs a correction process on the input image and outputs the resultant signal.

Each of the two-channel resolution converters 14R and 14B performs resolution conversion based on the input image signal. The high-resolution synthesis processor 15 receives image signals of three-channel green images, synthesizes the three-channel image signals, and outputs an image signal of a high resolution image. A color synthesis processor 17 receives red and blue image signals from the two-channel resolution converters 14R and 14B and the green image signal from the high-resolution synthesis processor 15, synthesizes the image signals, and outputs a high-resolution color image signal. An optical axis controller 162 analyzes an image signal obtained by synthesizing the image signals of the two-channel green images, and performs control to adjust incident optical axes of the two-channel image pickup units 10G2 and 10G3 so that the high-resolution image signal is obtained, based on the analysis result.

A correlation detection controller 71 receives a red image signal, a blue image signal, and a green image signal from the image processor 13R, the image processor 13B and the image processor 13G1, calculates a correlation value of three input images, and performs control so that the three images have a high correlation value. Since the same subject is picked up at the same time, the input red, blue and green image signals have a high correlation. This correlation is monitored to correct a relative shift of the red, green and blue images. Here, positions of the red image and the blue image are corrected using the image signal of the green image as a reference. An optical axis controller 163 analyzes an image signal obtained by synthesizing three-channel image signals (red, blue, and green), and performs control to adjust incident optical axes of the two-channel image pickup units 10R and 10B so that the high-resolution image signal is obtained, based on the analysis result.

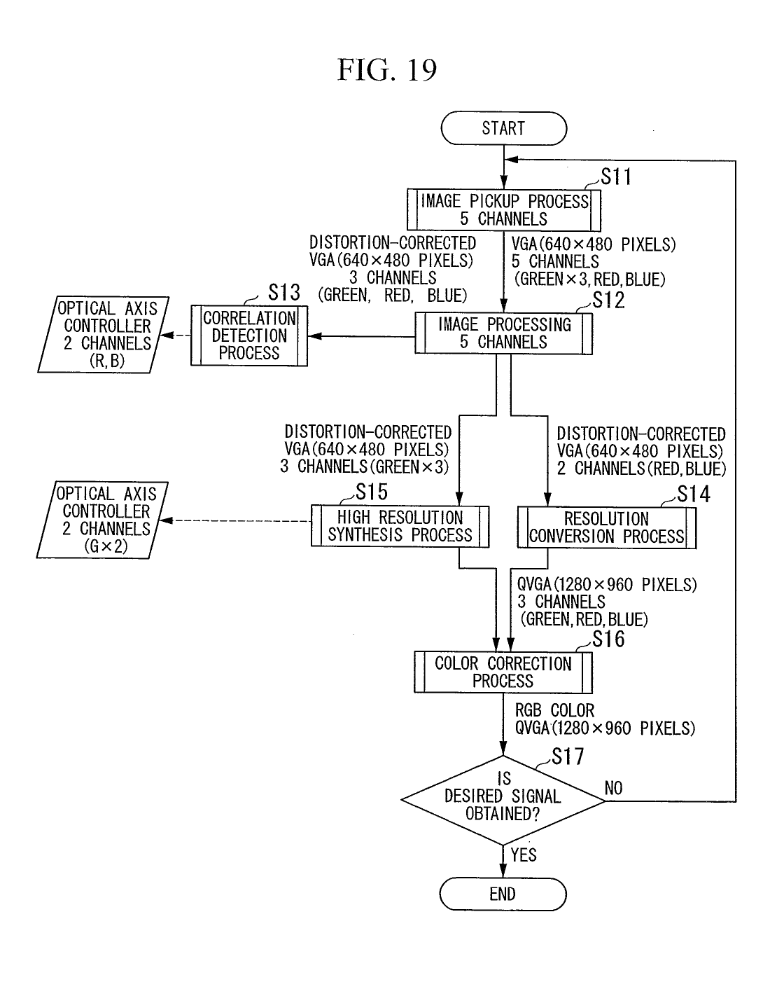

Next, an operation of the imaging device shown in FIG. 18 will be described with reference to FIG. 19. FIG. 19 is a flowchart showing an operation of the imaging device shown in FIG. 18. First, each of the five-channel image pickup units 10G1, 10G2, 10G3, 10R and 10B picks up an object and outputs an obtained image signal (VGA 640×480 pixels) (step S11). The five-channel image signals are input to the five-channel image processors 13G1, 13G2, 13G3, 13R and 13B. Each of the five-channel image processors 13G1, 13G2, 13G3, 13R and 13B performs image processing, i.e., a distortion correction process on the input image signal and outputs the resultant signal (step S12).

Next, the correlation detection controller 71 receives the red image signal, the blue image signal and the green image signal from the image processor 13R, the image processor 13B and the image processor 13G1, calculates the correlation value among three input images, and outputs a control signal to the optical axis controller 163 so that the optical axis controller 163 performs control such that the three images have a high correlation value (step S13). Accordingly, the control is performed to adjust incident optical axes of the two-channel image pickup units 10R and 10B.

Next, each of the two-channel resolution converters 14R and 14B performs a process of converting the resolution of the input distortion-corrected image signal (VGA 640×480 pixels) (step S14). Through this process, the two-channel image signals are converted into an image signal with quad-VGA 1280×960 pixels. Meanwhile, the high-resolution synthesis processor 15 performs a process of synthesizing the input distortion-corrected three-channel image signals (VGA 640×480 pixels) to achieve high resolution (step S15). The synthesis process is the same as in the first embodiment. Through the synthesis process, the three-channel image signals are synthesized and an image signal with quad-VGA 1280×960 pixels is output. In this case, the high-resolution synthesis processor 15 analyzes an image signal obtained by synthesizing the image signals of the three-channel green images, and outputs a control signal to the optical axis controller 162 so the optical axis controller 162 performs control to adjust the incident optical axes of the two-channel image pickup units 10G2 and 10G3 such that the high-resolution image signal is obtained, based on the analysis result.

Next, the color synthesis processor 17 receives the three-channel image signals (quad-VGA 1280×960 pixels) (red, blue, and green), synthesizes the three-channel image signals, and outputs a RGB color image signal (quad-VGA 1280×960 pixels) (step S16). The correlation detection controller 71 determines whether a signal of a desired correlation value is obtained or not, and repeatedly performs the process until the desired correlation value is obtained (step S17), and terminates the process when the desired correlation value is obtained.

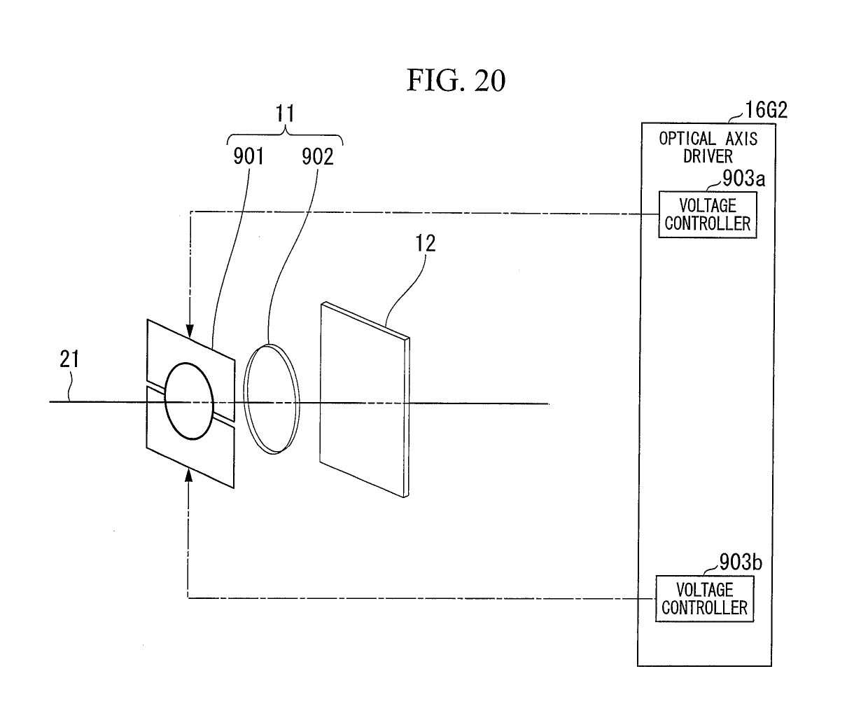

Next, an optical axis shift operation in the second embodiment will be described using a concrete example with reference to FIG. 20. The optical axis shift operation in the second embodiment differs from in the first embodiment is that a liquid crystal lens 901 includes two electrodes, to which two-channel voltage are applied by voltage controllers 903a and 903b. As shown in FIG. 20, an imaging lens 11 includes the liquid crystal lens 901 and an optical lens 902. The two-channel voltages are applied to the liquid crystal lens 901 by the two voltage controllers 903a and 903b constituting an optical axis driver 16G2, so that the optical axis shift is controlled.

The liquid crystal lens 901 has the same structure as shown in the cross-sectional view of FIG. 15. However, a second electrode 1004 having a circular hole 1004E is divided into upper and lower portions, such that the second electrode 1004 includes two electrodes to which voltages can be individually applied from the voltage controllers 903a and 903b. As shown in FIG. 17, according to the configuration in which the five-channel image pickup units are provided in a row, shift in a vertical direction can be reduced, and the optical axis adjustment through optical axis shift can be performed only through optical axis control only in a horizontal direction.

### Third Embodiment

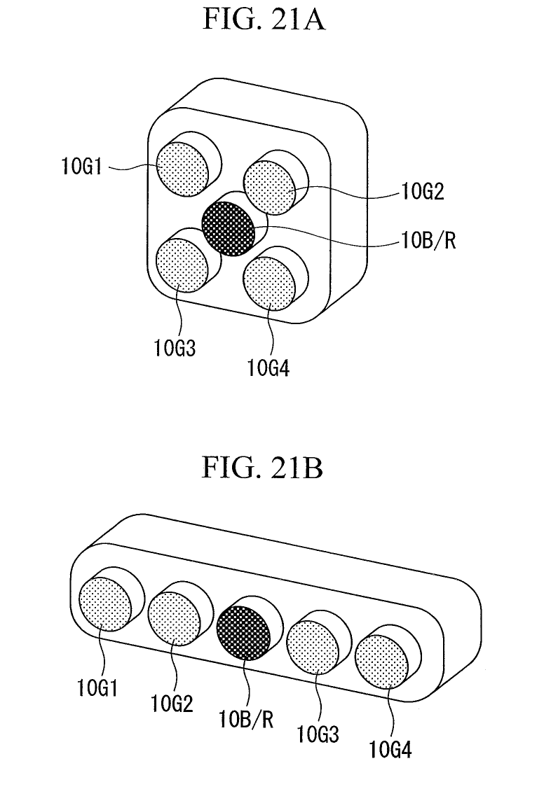

Next, an imaging device according to a third embodiment of the present invention will be described with reference to the accompanying drawings. FIGS. 21A and 21B show an appearance of the imaging device in the third embodiment. As shown in FIGS. 21A and 21B, the imaging device in the third embodiment includes a red and blue image pickup unit 10B/R that is a combination of a red image pickup unit 10R and a blue image pickup unit 10B, unlike the first and second embodiments. In the red and blue image pickup unit 10B/R, red and blue color filters having the same size as a pixel are provided in a checker pattern on a surface of an image pickup element, such that both a red image and a blue image can be picked up. Use of the red and blue image pickup unit 10B/R reduces the size and realizes one-channel optical axis shift control in the color synthesis processor 17, thereby reducing a processing amount.

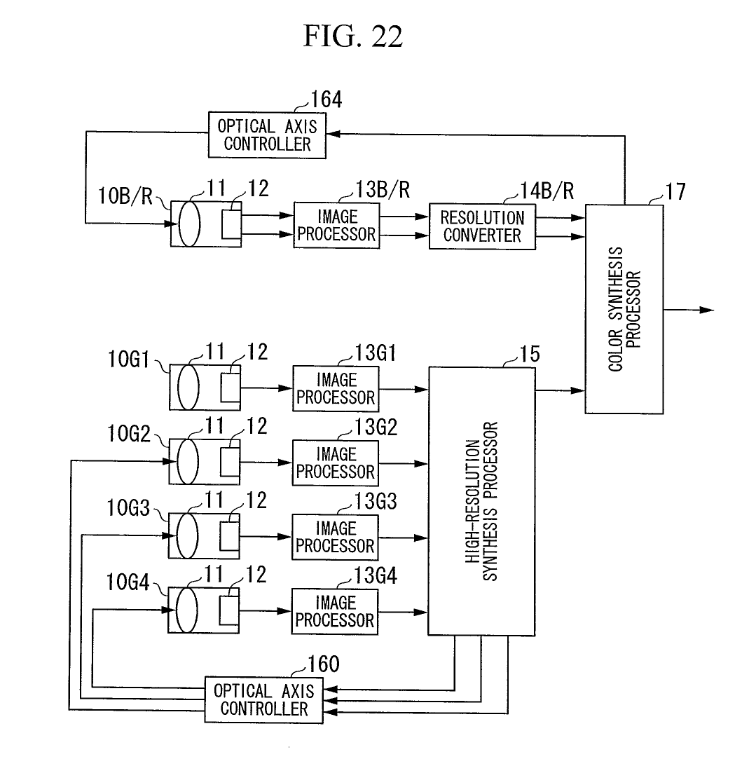

A configuration of the imaging device in the third embodiment will be described with reference to FIG. 22. Each of image pickup units 10G1, 10G2, 10G3, 10G4, and 10B/R includes an imaging lens 11 and an image pickup element 12. The imaging lens 11 forms an image on the image pickup element 12 using light from an imaging object, and the image pickup element 12 performs photoelectric conversion on the formed image and outputs an image signal. The image pickup element 12 is a low-power CMOS image pickup element. A specification of the CMOS image pickup element of the present embodiment includes pixel size of 5.6 μm×5.6 μm, a pixel pitch of 6 μm×6 μm, and an effective pixel number of 640 (horizontal)×480 (vertical), but is not particularly limited thereto. Image signals of images picked up by the five-channel image pickup units 10G1, 10G2, 10G3, 10G4, and 10B/R are respectively input to image processors 13G1, 13G2, 13G3, 13G4 and 13B/R. Each of the five-channel image processors 13G1, 13G2, 13G3, 13G4 and 13B/R performs a correction process on the input image and outputs the resultant signal.

A resolution converter 14B/R performs resolution conversion based on an input image signal of an image. A high-resolution synthesis processor 15 receives image signals of four-channel green images, synthesizes the four-channel image signals, and outputs an image signal of a high resolution image. The color synthesis processor 17 receives the red and blue image signal from the resolution converter 14B/R and the green image signal from the high-resolution synthesis processor 15, synthesizes the image signals, and outputs a high-resolution color image signal. An optical axis controller 160 analyzes an image signal obtained by synthesizing the image signals of the four-channel green images, and performs control to adjust incident optical axes of the three-channel image pickup units 10G2, 10G3 and 10G4 so that a high-resolution image signal is obtained, based on the analysis result. An optical axis controller 164 analyzes an image signal obtained by synthesizing the three-channel image signals (red, blue, and green) and performs control to adjust an incident optical axis of the image pickup unit 10B/R so that a high-resolution image signal is obtained, based on the analysis result.

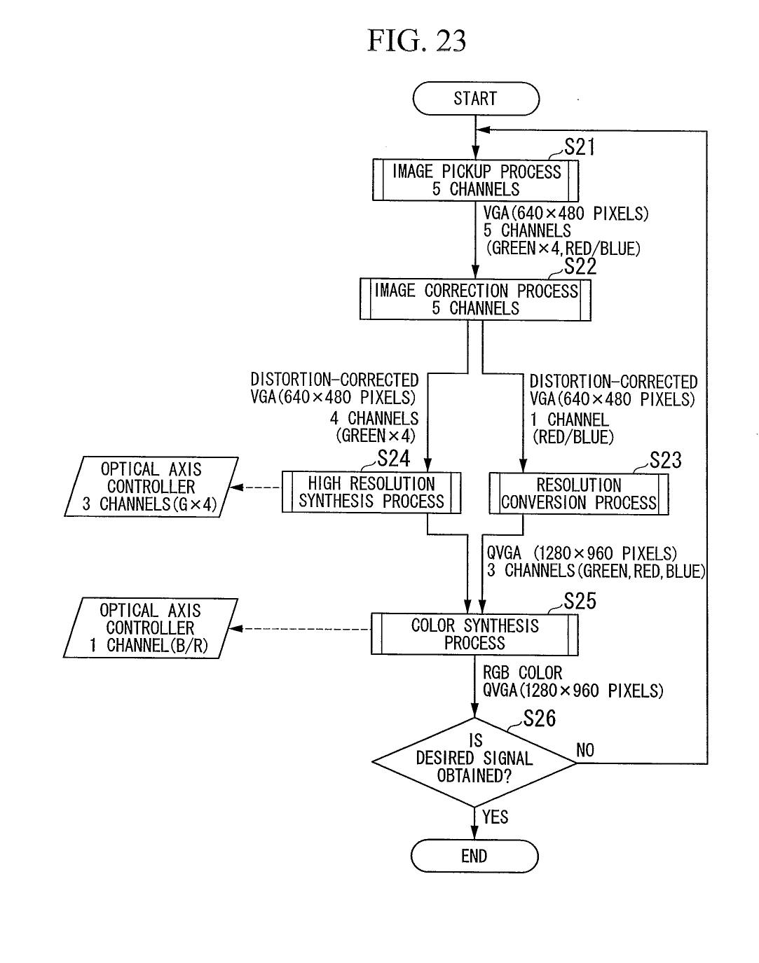

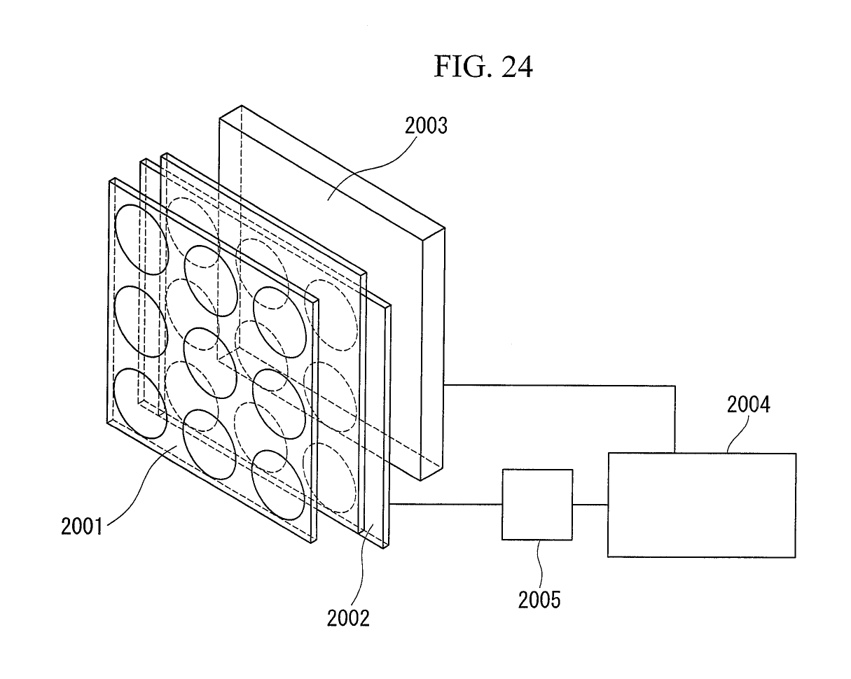

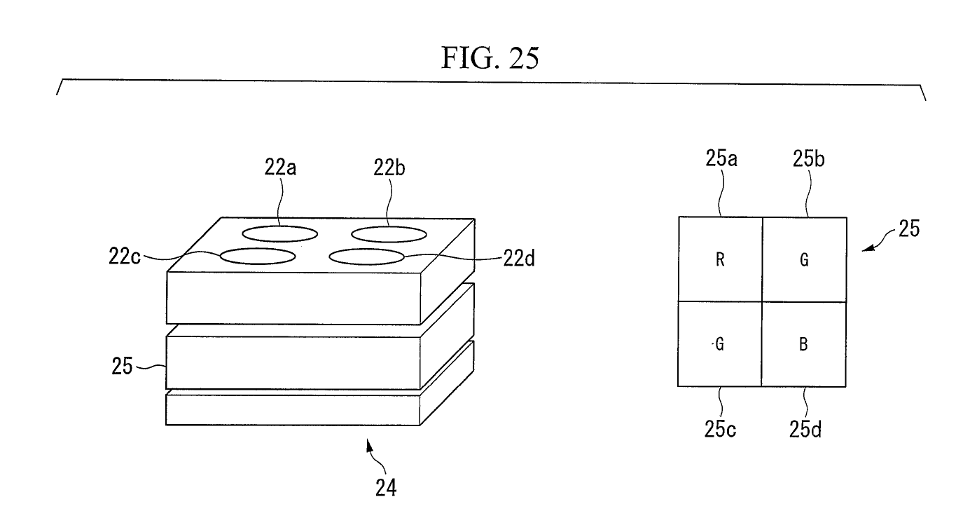

An operation of the imaging device shown in FIG. 22 will now be described with reference to FIG. 23. FIG. 23 is a flowchart showing an operation of the imaging device shown in FIG. 22. First, the five-channel image pickup units 10G1, 10G2, 10G3, 10G4, and 10B/R pick up an object, and output obtained image signals (VGA 640×480 pixels) (step S21). The five-channel image signals are input to the five-channel image processors 13G1, 13G2, 13G3, 13G4 and 13B/R. Each of the five-channel image processors 13G1, 13G2, 13G3, 13G4 and 13B/R performs a distortion correction process on the input image signal and outputs the resultant signal (step S22).

Next, the resolution converter 14B/R performs a process of converting the resolution of the input distortion-corrected image signal (VGA 640×480 pixels) (step S23). Through this process, a red and blue image signal is converted into an image signal with quad-VGA 1280×960 pixels. Meanwhile, the high-resolution synthesis processor 15 performs a process of synthesizing input distortion-corrected four-channel image signals (VGA 640×480 pixels) to achieve high resolution (step S24). Through the synthesis process, the four-channel image signals are synthesized and an image signal with quad-VGA 1280×960 pixels is output. In this case, the high-resolution synthesis processor 15 analyzes an image signal obtained by synthesizing the image signals of the four-channel green images, and outputs a control signal to the optical axis controller 160 so that the optical axis controller 160 performs control to adjust the incident optical axes of the three-channel image pickup units 10G2, 10G3 and 10G4 such that the high-resolution image signal is obtained, based on the analysis result.

Next, the color synthesis processor 17 receives the three-channel image signals (quad-VGA 1280×960 pixels) (red, blue, and green), synthesizes the three-channel image signals, and outputs a RGB color image signal (quad-VGA 1280×960 pixels) (step S25). In this case, the color synthesis processor 17 analyzes an image signal obtained by synthesizing the three three-channel image signals (red, blue, and green), and outputs a control signal to the optical axis controller 164 so that the optical axis controller 164 performs control to adjust the incident optical axis of the image pickup unit 10B/R such that the high-resolution image signal is obtained, based on the analysis result.

The color synthesis processor 17 determines whether a desired RGB color image signal is obtained or not, repeatedly performs the process until the desired RGB color image signal is obtained (step S26), and terminates the process when the desired RGB color image signal is obtained.

As described above, the optical axes are adjusted so that the resolution of the green image obtained by synthesizing the plurality of images picked up by a plurality of green image pickup units becomes a predetermined resolution, to acquire a high-resolution green image, and the optical axis is adjusted so that both the correlation value between the high-resolution green image and the red image picked up by the red image pickup unit and the correlation value between the green image and the blue image picked up by the blue image pickup unit become a predetermined correlation value, and the green image, the red image and the blue image are synthesized, thereby creating a high-resolution full color image without color shift.

1. An imaging device comprising:
a plurality of green image pickup units each comprising a first image pickup element which picks up an image of a green component and a first optical system which forms an image on the first image pickup element;
a red image pickup unit comprising a second image pickup element which picks up an image of a red component and a second optical system which forms an image on the second image pickup element;
a blue image pickup unit comprising a third image pickup element which picks up an image of a blue component and a third optical system which forms an image on the third image pickup element;
a high-definition synthesis processor which adjusts an optical axis of light incident to the green image pickup units, so that the resolution of a green image obtained by synthesizing a plurality of images picked up by the plurality of green image pickup units becomes a predetermined resolution, and synthesizes the plurality of images to obtain a high-resolution green image; and
a color synthesis processor which adjusts an optical axis of light incident to each of the red image pickup unit and the blue image pickup unit, so that both a correlation value between the high-resolution green image obtained by the high-definition synthesis processor and a red image picked up by the red image pickup unit and a correlation value between the high-resolution green image and a blue image picked up by the blue image pickup unit become a predetermined correlation value, and synthesizes the green image, the red image and the blue image to obtain a color image.

2. The imaging device according to claim 1, wherein the first, second and third optical systems comprise a non-solid lens with a changeable refractive index distribution, and an optical axis of light incident to the image pickup element is adjusted by changing the refractive index distribution of the non-solid lens.

3. The imaging device according to claim 2, wherein the non-solid lens is a liquid crystal lens.

4. The imaging device according to claim 1, wherein the high-definition synthesis processor analyzes a spatial frequency of the green image obtained by synthesizing the plurality of images picked up by the plurality of green image pickup units, determines whether the power of a high spatial frequency band component is greater than or equal to a predetermined high-resolution determination threshold or not, and adjusts the optical axis based on the determination result.

5. The imaging device according to claim 1, wherein the red image pickup unit and the blue image pickup unit are provided between the plurality of green image pickup units.

6. The imaging device according to claim 1, wherein the plurality of green image pickup units, the red image pickup unit and the blue image pickup unit are provided in a row.

7. An imaging device comprising:
a plurality of green image pickup units each comprising a first image pickup element which picks up an image of a green component and a first optical system which forms an image on the first image pickup element;
a red image pickup unit comprising a second image pickup element which picks up an image of a red component and a second optical system which forms an image on the second image pickup element;
a blue image pickup unit comprising a third image pickup element which picks up an image of a blue component and a third optical system which forms an image on the third image pickup element;
a high-definition synthesis processor which adjusts an optical axis of light incident to the green image pickup units, so that the resolution of a green image obtained by synthesizing a plurality of images picked up by the plurality of green image pickup units becomes a predetermined resolution, and synthesizes the plurality of images to obtain a high-resolution green image; and
a color synthesis processor which adjusts an optical axis of light incident to each of the red image pickup unit and the blue image pickup unit, so that both a correlation value between a green image obtained by the green image pickup unit provided between the red image pickup unit and the blue image pickup unit and a red image picked up by the red image pickup unit and a correlation value between the green image and a blue image picked up by the blue image pickup unit become a predetermined correlation value, and synthesizes the green image, the red image and the blue image to obtain a color image.

8. An imaging device comprising:
a plurality of green image pickup units each comprising a first image pickup element which picks up an image of a green component and a first optical system which forms an image on the first image pickup element;
a red and blue image pickup unit comprising a second image pickup element which picks up an image of a red component and an image of a blue component and a second optical system which forms an image on the second image pickup element;
a high-definition synthesis processor which adjusts an optical axis of light incident to the green image pickup units, so that the resolution of a green image obtained by synthesizing a plurality of images picked up by the plurality of green image pickup units becomes a predetermined resolution, and synthesizes the plurality of images to obtain a high-resolution green image; and
a color synthesis processor which adjusts an optical axis of light incident to the red and blue image pickup unit, so that both a correlation value between the high-resolution green image obtained by the high-definition synthesis processor and a red image picked up by the red and blue image pickup unit and a correlation value between the high-resolution green image and a blue image picked up by the red and blue image pickup unit become a predetermined correlation value, and synthesizes the green image, the red image and the blue image to obtain a color image.

9. A method of controlling an optical axis in an imaging device, comprising:
a plurality of green image pickup units each comprising a first image pickup element which picks up an image of a green component and a first optical system which forms an image on the first image pickup element;
a red image pickup unit comprising a second image pickup element which picks up an image of a red component and a second optical system which forms an image on the second image pickup element; and
a blue image pickup unit comprising a third image pickup element which picks up an image of a blue component and a third optical system which forms an image on the third image pickup element, the method comprising:
adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and
adjusting an optical axis of light incident to each of the red image pickup unit and the blue image pickup unit, so that both a correlation value between the high-resolution green image obtained by the synthesis and a red image picked up by the red image pickup unit and a correlation value between the high-resolution green image and a blue image picked up by the blue image pickup unit become a predetermined correlation value, and synthesizing the green image, the red image and the blue image to obtain a color image.

10. A method of controlling an optical axis in an imaging device, comprising:
a plurality of green image pickup units each comprising a first image pickup element which picks up an image of a green component and a first optical system which forms an image on the first image pickup element;
a red image pickup unit comprising a second image pickup element which picks up an image of a red component and a second optical system which forms an image on the second image pickup element; and
a blue image pickup unit comprising a third image pickup element which picks up an image of a blue component and a third optical system which forms an image on the third image pickup element, the method comprising:
adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and
adjusting an optical axis of light incident to each of the red image pickup unit and the blue image pickup unit, so that both a correlation value between a green image obtained by the green image pickup unit provided between the red image pickup unit and the blue image pickup unit and a red image picked up by the red image pickup unit and a correlation value between the green image and a blue image picked up by the blue image pickup unit become a predetermined correlation value, and synthesizing the green image, the red image and the blue image to obtain a color image.

11. A method of controlling an optical axis in an imaging device, comprising:
a plurality of green image pickup units each comprising a first image pickup element which picks up an image of a green component and a first optical system which forms an image on the first image pickup element; and
a red and blue image pickup unit comprising a second image pickup element which picks up an image of a red component and an image of a blue component and a second optical system which forms an image on the second image pickup element, the method comprising:
adjusting an optical axis of light incident to the green image pickup units, so that the resolution of a green image obtained by synthesizing a plurality of images picked up by the plurality of green image pickup units becomes a predetermined resolution, and synthesizing the plurality of images to obtain a high-resolution green image; and
adjusting an optical axis of light incident to the red and blue image pickup unit, so that both a correlation value between the high-resolution green image obtained by the synthesis and a red image picked up by the red and blue image pickup unit and a correlation value between the high-resolution green image and a blue image picked up by the red and blue image pickup unit become a predetermined correlation value, and synthesizing the green image, the red image and the blue image to obtain a color image.
